(19) United States
(12) Patent Application Publication
(10) Pub. No.: US 2022/0223831 A1
(43) Pub. Date: Jul. 14, 2022

(54) SECONDARY BATTERY AND MANUFACTURING METHOD OF POSITIVE ELECTRODE ACTIVE MATERIAL

(71) Applicant: SEMICONDUCTOR ENERGY LABORATORY CO., LTD., Atsugi-shi (JP)

(72) Inventors: Yusuke YOSHITANI, Isehara (JP); Takashi HIRAHARA, Atsugi (JP); Noriko MIYAIRI, Hadano (JP); Masahiko HAYAKAWA, Atsugi (JP); Yohei MOMMA, Isehara (JP)

(21) Appl. No.: 17/565,031

(22) Filed: Dec. 29, 2021

(30) Foreign Application Priority Data
Jan. 8, 2021 (JP) 2021-001989
Feb. 12, 2021 (JP) 2021-020833

(51) Int. Cl. H01M 4/04

(52) U.S. Cl. CPC H01M 4/0416; H01M 2004/028; H01M 4/0471

(57) ABSTRACT

To provide a positive electrode active material with high charge and discharge capacity, or a novel positive electrode active material. The positive electrode active material is formed in the following manner: a cobalt compound (also referred to as a precursor) containing nickel, cobalt, and manganese is obtained by a coprecipitation method; a mixture obtained by mixing a lithium compound, the cobalt compound, and an additive is heated at first heating temperature; and the heated mixture is ground or crushed and further heated at second heating temperature that is higher than the first heating temperature. The first heating temperature is higher than or equal to 400° C. and lower than or equal to 700° C. The second heating temperature is higher than 700° C. and lower than or equal to 1050° C.

### BACKGROUND OF THE INVENTION

### 1. Field of the Invention

One embodiment of the present invention relates to a positive electrode active material, a secondary battery, and manufacturing methods of the positive electrode active material and the secondary battery. Furthermore, one embodiment of the present invention relates to a portable information terminal and a vehicle each including a secondary battery.

One embodiment of the present invention relates to an object or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that in this specification, a semiconductor device generally means a device that can function by utilizing semiconductor characteristics. An electrooptic device, a semiconductor circuit, and an electronic device are all semiconductor devices.

Note that a power storage device in this specification refers to every element and device having a function of storing electric power. For example, a power storage device (also referred to as secondary battery) such as a lithium-ion secondary battery, a lithium-ion capacitor, and an electric double layer capacitor are included in the category of the power storage device.

### 2. Description of the Related Art

In recent years, a variety of power storage devices, such as lithium-ion secondary batteries, lithium-ion capacitors, and air batteries, have been actively developed. In particular, demand for lithium-ion secondary batteries with high output and high energy density has rapidly grown with the development of the semiconductor industry, for portable information terminals such as mobile phones, smartphones, and laptop computers; portable music players; digital cameras; medical equipment; next-generation clean energy vehicles such as hybrid vehicles (HVs), electric vehicles (EVs), and plug-in hybrid vehicles (PHVs); and the like. The lithium-ion secondary batteries are essential for today's information society as rechargeable energy supply sources.

Patent Document 1 discloses a positive electrode active material for a lithium-ion secondary battery with high capacity and excellent charge and discharge cycle performance.

### REFERENCE

### Patent Document

[Patent Document 1] PCT International Publication No. WO2020/099978

### SUMMARY OF THE INVENTION

An object of one embodiment of the present invention is to provide a positive electrode active material with high charge and discharge capacity. Another object is to provide a positive electrode active material with high charge and discharge voltage. Another object is to provide a positive electrode active material that is less likely to deteriorate. Another object is to provide a novel positive electrode active material. Another object is to provide a secondary battery with high charge and discharge capacity. Another object is to provide a secondary battery with high charge and discharge voltage. Another object is to provide a secondary battery with high safety or high reliability. Another object is to provide a secondary battery that is less likely to deteriorate. Another object is to provide a secondary battery with a long lifetime. Another object is to provide a novel secondary battery.

Another object of one embodiment of the present invention is to provide a novel substance, active material, or power storage device or a manufacturing method thereof.

Note that the description of these objects does not preclude the existence of other objects. One embodiment of the present invention does not have to achieve all these objects. Other objects can be derived from the description of the specification, the drawings, and the claims.

In the invention disclosed in this specification, a positive electrode active material is formed in such a manner that a cobalt compound (also referred to as a precursor) is obtained by a coprecipitation method, a mixture obtained by mixing the cobalt compound and a lithium compound is heated at first heating temperature, the heated mixture is ground or crushed, and further heated at second heating temperature that is higher than the first heating temperature.

Moisture is released by the heating at the first heating temperature, and then heating is performed at the second heating temperature that is higher than the first heating temperature. Performing the heat treatment twice can improve the mixing state of the mixture, and when a secondary battery is fabricated with the mixture, voids of a secondary particle in the secondary battery can be reduced. Furthermore, the twice heat treatment can improve the crystallinity.

The first heating temperature is higher than or equal to 400° C. and lower than or equal to 700° C.

The second heating temperature is higher than 700° C. and lower than or equal to 1050° C.

In the case where an additive element typified by aluminum is added to the mixture, a lithium compound and an aluminum compound are added before the heat treatment at the first heating temperature.

One embodiment of the invention disclosed in this specification is a method of forming a positive electrode active material, including: supplying an aqueous solution containing a water-soluble nickel salt, a water-soluble cobalt salt, and a water-soluble manganese salt and an alkaline solution to a reaction tank; performing mixing in the reaction tank to precipitate a cobalt compound; heating a mixture obtained by mixing the cobalt compound, a lithium compound, and an aluminum compound at first heating temperature; performing grinding or crushing on the mixture; and heating the ground or crushed mixture at second heating temperature that is higher than the first heating temperature.

By the coprecipitation method of precipitating the cobalt compound, an aqueous solution containing a water-soluble nickel salt, a water-soluble cobalt salt, and a water-soluble manganese salt and an alkaline solution are supplied to a reaction tank, mixing is performed in the reaction tank to precipitate a cobalt compound (hydroxide containing cobalt, manganese, and nickel), and the cobalt compound and a lithium compound are mixed to form a mixture. The reaction is referred to as a neutralization reaction, an acid-base reaction, or a coprecipitation reaction in some cases. The compound containing at least nickel, cobalt, and manganese is referred to as a cobalt compound or a precursor of lithium cobaltate in some cases regardless of the contained amount of cobalt.

As the aqueous solution containing a water-soluble nickel salt, a nickel sulfate aqueous solution or a nickel nitrate aqueous solution can be used.

As the aqueous solution containing a water-soluble cobalt salt, a cobalt sulfate aqueous solution or a cobalt nitrate aqueous solution can be used.

As the aqueous solution containing a water-soluble manganese salt, a manganese sulfate aqueous solution or a manganese nitrate aqueous solution can be used.

In the case where aluminum is added as an additive element to the mixture, an aqueous solution containing aluminum is further supplied to the reaction tank. In the case where magnesium is added as an additive element to the mixture, an aqueous solution containing magnesium is further supplied to the reaction tank. In the case where calcium is added as an additive element to the mixture, an aqueous solution containing calcium is further supplied to the reaction tank.

The pH inside the reaction tank is preferably greater than or equal to 9.0 and less than or equal to 11.0, more preferably greater than or equal to 10.0 and less than or equal to 10.5.

When an aqueous solution and an alkaline solution are mixed to precipitate a cobalt compound, a chelating agent is added. Examples of the chelating agent include glycine, oxine, 1-nitroso-2-naphthol, 2-mercaptobenzothiazole, and ethylenediaminetetraacetic acid (EDTA). Note that two or more kinds selected from glycine, oxine, 1-nitroso-2-naphthol, and 2-mercaptobenzothiazole may be used. The chelating agent is dissolved in pure water, which is used as a chelate aqueous solution. The chelating agent is a complexing agent that forms a chelate compound, and preferred to a general complexing agent. A complexing agent may be used instead of the chelating agent, and an example of the complexing agent is an ammonia water.

The use of the chelate aqueous solution is preferable because it is easy to control the pH in the reaction tank for obtaining a cobalt compound. Furthermore, the use of the chelate aqueous solution is preferable also because the chelate aqueous solution prevents generation of unnecessary crystal nuclei and promotes crystal growth. When unnecessary nuclei are prevented from occurring, impalpable particles are also prevented from occurring; accordingly, a composite hydroxide with favorable particle size distribution can be obtained. The use of the chelate aqueous solution can retard an acid-base reaction, and the reaction that gradually progresses can result in almost-spherical secondary particles. Glycine has a function of keeping the pH greater than or equal to 9.0 and less than or equal to 10.0 or the vicinity of the range. Using a glycine aqueous solution as the chelate aqueous solution is preferable because it is easy to control the pH of the reaction tank for obtaining the cobalt compound. Furthermore, the concentration of glycine in the glycine aqueous solution is preferably greater than or equal to 0.05 mol/L and less than or equal to 0.09 mol/L.

The positive electrode active material obtained in the above manner includes crystal having a hexagonal crystal layered structure. The crystal is not limited to a single crystal (also referred to as a crystallite). In the case where the crystal is polycrystalline, some crystallites gather to form a primary particle. The primary particle indicates a particle recognized as a grain having a single smooth plane when observed with a scanning electron microscope (SEM). The secondary particle indicates a group of aggregated primary particles. In the SEM observation, boundaries or color differences are observed between primary particles which are different in crystallinity, crystal orientation, or composition. Thus, the different primary particles can be visually recognized as different regions in many cases. For the aggregation of the primary particles, there is no particular limitation on the bonding force between the plurality of primary particles. The bonding force may be one of covalent bonding, ionic bonding, a hydrophobic interaction, the Van der Waals force, and other molecular interactions, or a plurality of bonding forces may work together.

When the coprecipitation method is employed, the secondary particle is formed in some cases.

The crystal having a hexagonal crystal layered structure includes one or more selected from a first transition metal, a second transition metal, and a third transition metal. Specifically, NiCoMn-based material (also referred to as NCM) represented by LiNiₓCo_{y}Mn_{z}O₂ (x>0, y>0, z>0, 0.8<x+y+z<1.2) where the first transition metal is nickel, the second transition metal is cobalt, and the third transition metal is manganese, can be used. Specifically, it is preferable that the relations 0.1x<y<8x and 0.1x<z<8x be satisfied, for example. For example, x, y, and z preferably satisfy the ratio x:y:z=1:1:1 or the neighborhood thereof. Alternatively, for example, x, y, and z preferably satisfy the ratio x:y:z=5:2:3 or the neighborhood thereof, x:y:z=8:1:1 or the neighborhood thereof, x:y:z=9:0.5:0.5 or the neighborhood thereof, x:y:z=6:2:2 or the neighborhood thereof, or x:y:z=1:4:1 or the neighborhood thereof.

The positive electrode active material obtained in the above manner may contain one or more selected from a group formed of Al, Mg, Ca, Zr, V, Cr, Fe, Cu, Zn, Ga, Ge, Sr, Y, Nb, Mo, Sn, Ba, and La as necessary, in addition to the first transition metal, the second transition metal, and the third transition metal. In order that a secondary battery including the positive electrode active material has higher capacity retention rate after charge and discharge cycles, the positive electrode active material preferably contains Al, Mg, Ca, or Zr.

The secondary battery including the positive electrode active material is also a structure disclosed in this specification. The secondary battery includes a positive electrode including the positive electrode active material and a negative electrode including a negative electrode active material. A separator is positioned between the positive electrode and the negative electrode. The separator is used for preventing short circuit, providing a secondary battery with high safety or high reliability.

In the case where aluminum is added to the positive electrode active material, when the above method is regarded as the first method, there are other methods. The second method is a method in which after the heat treatment is performed at the second heating temperature, aluminum is added. The third method is a method using an aqueous solution containing aluminum as one of aqueous solutions used for the coprecipitation method.

As described above, there are three methods of adding aluminum to the positive electrode active material. In the case where aluminum is added to the positive electrode active material, one or more of the above three methods can be employed. For example, in the case where a large amount of aluminum is added, the following procedure is possible: aluminum is added with use of an aluminum-containing aqueous solution at the time of the coprecipitation method, lithium and aluminum are added and mixed, heating is performed at the first heating temperature to release moisture, heating is performed at the second heating temperature that is higher than the first heating temperature, aluminum is added after the second heating, and then third heating is performed.

Performing heat treatment twice in one embodiment of the present invention improves the mixing state of the mixture, which can reduce voids of the secondary particle when a secondary battery is fabricated. In addition, heat treatment performed twice in total can improve the crystallinity. Thus, a positive electrode active material with high capacity can be provided. A positive electrode active material which is relatively stable even when charge and discharge are repeated can be provided. A highly safe or highly reliable secondary battery can be provided.

Note that the description of these effects does not preclude the existence of other effects. One embodiment of the present invention does not necessarily have all the effects listed above. Other effects will be apparent from and can be derived from the description of the specification, the drawings, and the claims.

### BRIEF DESCRIPTION OF THE DRAWINGS

FIG. 1 shows an example of a formation flow of a positive electrode active material of one embodiment of the present invention.

FIG. 2 shows an example of a formation flow of a positive electrode active material of one embodiment of the present invention.

FIG. 3 shows an example of a formation flow of a positive electrode active material of one embodiment of the present invention.

FIG. 4 shows an example of a formation flow of a positive electrode active material of one embodiment of the present invention.

FIG. 5 is a cross-sectional view showing a reaction tank used in one embodiment of the present invention.

FIG. 6A is a perspective exploded view of a coin-type secondary battery, FIG. 6B is a perspective view of a coin-type secondary battery, and FIG. 6C is a cross-sectional perspective view thereof.

FIG. 7A shows an example of a cylindrical secondary battery. FIG. 7B shows an example of a cylindrical secondary battery. FIG. 7C shows an example of a plurality of cylindrical secondary batteries. FIG. 7D shows an example of a power storage system including a plurality of cylindrical secondary batteries.

FIGS. 8A and 8B show examples of a secondary battery, and FIG. 8C illustrates the internal state of a secondary battery.

FIGS. 9A to 9C show an example of a secondary battery.

FIGS. 10A and 10B each show the appearance of a secondary battery.

FIGS. 11A to 11C show a method of manufacturing a secondary battery.

FIGS. 12A to 12C show structure examples of a battery pack.

FIGS. 13A and 13B show an example of a secondary battery.

FIGS. 14A to 14C show an example of a secondary battery.

FIGS. 15A and 15B show an example of a secondary battery.

FIG. 16A is a perspective view of a battery pack of one embodiment of the present invention, FIG. 16B is a block diagram of a battery pack, and FIG. 16C is a block diagram of a vehicle having a motor.

FIGS. 17A to 17D show examples of transport vehicles.

FIGS. 18A and 18B show power storage devices of embodiments of the present invention.

FIG. 19A shows an electric bicycle, FIG. 19B shows a secondary battery of the electric bicycle, and FIG. 19C shows an electric motorcycle.

FIGS. 20A to 20D show examples of electronic devices.

FIG. 21 shows the results of crushing strength.

FIG. 22 shows a cross-sectional observation photograph of a positive electrode.

FIGS. 23A and 23B show charge and discharge cycle performance of secondary batteries at 25° C.

FIGS. 24A and 24B show charge and discharge cycle performance of secondary batteries at 45° C.

FIG. 25 is a SEM image of particles in this example.

FIG. 26 is a SEM image of particles in a comparative example.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

### Embodiment 1

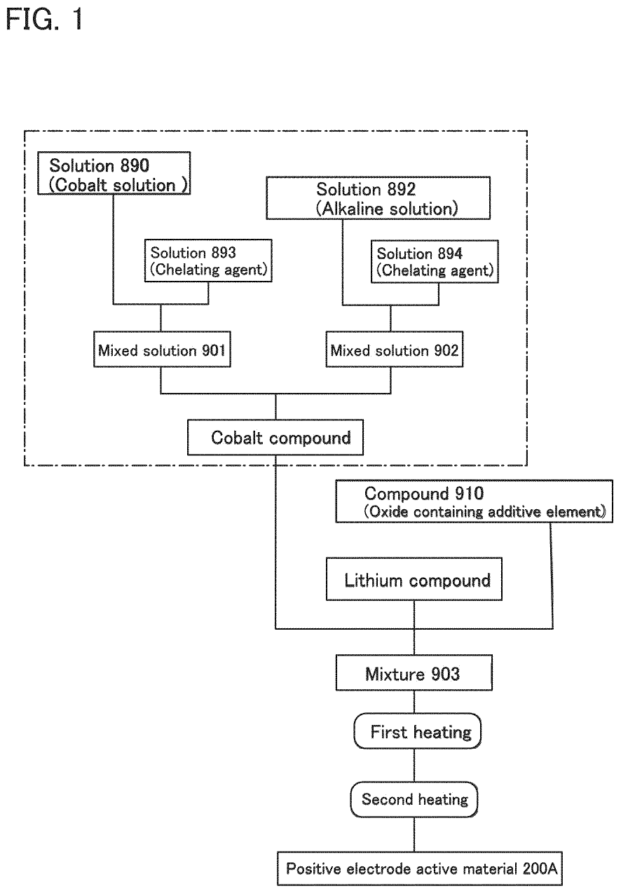

In this embodiment, an example of a method of forming a positive electrode active material 200A in which an additive element is added to a cobalt compound obtained by a coprecipitation method will be described with reference to FIG. 1. Note that the flow diagram in FIG. 1 shows the order of components (the order of steps) connected with lines. FIG. 1 does not show timings of components which are not directly connected with lines. For example, although a mixed solution 901 and a mixed solution 902 are shown at the same level in FIG. 1, steps or treatments of the mixed solutions 901 and 902 are not necessarily performed at the same time.

In this embodiment, a coprecipitation precursor where Co, Ni, and Mn exist in one particle is formed by a coprecipitation method, a lithium salt and aluminum are mixed to the coprecipitation precursor, and then heating is performed.

As shown in FIG. 1, a cobalt aqueous solution is prepared as an aqueous solution 890, and an alkaline solution is prepared as an aqueous solution 892. The aqueous solution 890 and an aqueous solution 893 are mixed to form the mixed solution 901. The aqueous solution 892 and an aqueous solution 894 are mixed to form the mixed solution 902. These mixed solutions 901 and 902 are made to react to form a cobalt compound. This reaction is referred to as a neutralization reaction, an acid-base reaction, or a coprecipitation reaction, and this cobalt compound is referred to as a precursor of lithium cobaltate (or a coprecipitation precursor) in some cases. Note that a reaction caused by performing steps surrounded by the chain line in FIG. 1 can be referred to as a coprecipitation reaction.

### <Cobalt Aqueous Solution>

An example of the cobalt aqueous solution is an aqueous solution containing cobalt sulfate (e.g., CoSO₄), cobalt chloride (e.g., CoCl₂), cobalt nitrate (e.g., Co(NO₃)₂), cobalt acetate (e.g., C₄H₆CoO₄), cobalt alkoxide, an organocobalt complex, or hydrate of any of these. Alternatively, instead of the cobalt aqueous solution, an organic acid of cobalt, such as cobalt acetate, or hydrate of the organic acid of cobalt may be used. Note that in this specification, the organic acid includes citric acid, oxalic acid, formic acid, and butyric acid, in addition to acetic acid.

For example, an aqueous solution obtained by dissolving these in pure water can be used. The cobalt aqueous solution shows acidity, and thus can be referred to as an acid aqueous solution. The cobalt aqueous solution can be referred to as a cobalt source in a process of forming a positive electrode active material.

### <Nickel Aqueous Solution>

As a nickel aqueous solution, an aqueous solution of nickel sulfate, nickel chloride, nickel nitrate, or hydrate of any of these can be used. Alternatively, an aqueous solution of an organic acid salt of nickel, such as nickel acetate, or hydrate of the organic acid salt of nickel can be used. Alternatively, an aqueous solution of nickel alkoxide or an organonickel complex can be used. The nickel aqueous solution can be referred to as a nickel source in a process of forming a positive electrode active material.

### <Manganese Aqueous Solution>

As a manganese aqueous solution, an aqueous solution of manganese salt, such as manganese sulfate, manganese chloride, or manganese nitrate, or hydrate of any of these can be used. Alternatively, an aqueous solution of an organic acid salt of manganese, such as manganese acetate, or hydrate of the organic acid salt of manganese can be used. Alternatively, an aqueous solution of manganese alkoxide or an organomanganese complex can be used. The manganese aqueous solution can be referred to as a manganese source in a process of forming a positive electrode active material.

The above-described cobalt aqueous solution, nickel aqueous solution, and manganese aqueous solution are prepared and mixed, whereby the aqueous solution 890 is formed.

### <Alkaline Solution>

An example of the alkaline solution is an aqueous solution containing sodium hydroxide, potassium hydroxide, lithium hydroxide, or ammonia. For example, an aqueous solution obtained by dissolving any of these in pure water can be used. An aqueous solution obtained by dissolving two or more kinds selected from sodium hydroxide, potassium hydroxide, and lithium hydroxide in pure water may be used.

### <Reaction Conditions>

In the case where the aqueous solution 890 and the aqueous solution 892 are made to react by the coprecipitation method, the pH of the reaction system is set to greater than or equal to 9.0 and less than or equal to 11.0, and preferably greater than or equal to 9.8 and less than or equal to 10.3. For example, in the case where the aqueous solution 892 is put into a reaction tank and the aqueous solution 890 is dropped into the reaction tank, the pH of the aqueous solution in the reaction tank is preferably kept in the above range. The same applies to the case where the aqueous solution 890 is put into the reaction tank and the aqueous solution 892 is dropped. The dropping rate of the aqueous solution 890 or the aqueous solution 892 is preferably greater than or equal to 0.1 mL/min. and less than or equal to 0.8 mL/min., in which case the pH condition can be controlled easily. The reaction tank includes at least a reaction container.

An aqueous solution in the reaction tank is preferably stirred with a stirring means. The stirring means includes a stirrer or an agitator blade. Two to six agitator blades can be provided; for example, in the case where four agitator blades are provided, they may be placed in a cross shape seen from above. The number of rotations of the stirring means is preferably greater than or equal to 800 rpm and less than or equal to 1200 rpm.

The temperature in the reaction tank is adjusted to be higher than or equal to 50° C. and lower than or equal to 90° C. The dropping of the aqueous solution 892 or the aqueous solution 890 is preferably started after the temperature becomes the above temperature.

The inside of the reaction tank is preferably an inert atmosphere. For example, in the case of a nitrogen atmosphere, a nitrogen gas is preferably introduced at a flow rate of 0.5 L/min. or more and 2 L/min. or less.

In the reaction tank, a reflux condenser is preferably provided. With the reflux condenser, the nitrogen gas can be released from the reaction tank and water can be returned to the reaction tank.

Through the above reaction, a cobalt compound is precipitated in the reaction tank. Filtration is performed to collect the cobalt compound. After a reaction product precipitated in the reaction tank is washed with pure water, an organic solvent (e.g., acetone) having a low boiling point is preferably added before the filtration is performed.

The cobalt compound after the filtration is preferably dried. For example, drying is performed in a vacuum at 60° C. or higher and 90° C. or lower for 0.5 hours or longer and 3 hours or shorter. In this manner, the cobalt compound can be obtained.

The cobalt compound obtained through the above reaction includes cobalt hydroxide (e.g., Co(OH)₂). The cobalt hydroxide after the filtration is obtained as the secondary particle which is aggregation of the primary particles. In this specification, the secondary particle refers to the primary particles which agglutinate to share part of grain boundaries (an outer periphery of the primary particles) and do not easily separate from one another (independent particles). That is, the secondary particle may have a grain boundary.

Next, a lithium compound and a compound 910 as an oxide containing an additive element are prepared.

### <Lithium Compound>

Examples of the lithium compound include lithium hydroxide (e.g., LiOH), lithium carbonate (e.g., Li₂CO₃), and lithium nitrate (e.g., LiNO₃). In particular, a material having a low melting point among lithium compounds, such as lithium hydroxide (melting point: 462° C.), is preferably used. Since a positive electrode active material having a high nickel proportion is likely to cause cation mixing as compared to lithium cobaltate, first heating needs to be performed at low temperature. Therefore, it is preferable to use a material having a low melting point. The lithium compound is weighed out such that the number of lithium atoms is larger than 0.89 and smaller than 1.07 when the total number of nickel atoms, cobalt atoms, manganese atoms, and oxygen atoms is 1.

### <Compound 910>

As an additive element source, one or more selected from an aluminum salt, a magnesium salt, and a calcium salt are used. As the compound 910, one or more selected from aluminum oxide, aluminum hydroxide, magnesium oxide, magnesium hydroxide, basic magnesium carbonate ((MgCO₃)₃Mg(OH)₂.3H₂O), calcium oxide, calcium carbonate, and calcium hydroxide are used. In this embodiment, an aluminum salt is used as the additive element source and aluminum hydroxide (Al(OH)₃) is used as the compound 910. The compound 910 used as the additive element source is weighed out to be contained with a desired amount by a practitioner in consideration of the composition of the cobalt compound. For example, when the sum of nickel, cobalt, manganese, and oxygen contained in the cobalt compound is regarded as 1, aluminum, magnesium, or calcium is preferably added in the range greater than or equal to 0.5 atomic % and less than or equal to 3 atomic % of the sum.

In this embodiment, the cobalt compound, the lithium compound, and the aluminum hydroxide were weighed out to have desired amounts and mixed to form a mixture 903. For the mixing, a mortar or a stirring mixer is used.

Next, the first heating is performed. As a firing device used for the first heating, an electric furnace such as rotary kiln can be used.

Then, grinding or crushing is performed with a mortar to loosen the secondary particles fixed one another, and the ground or crushed mixture is collected. Furthermore, classification may be performed using a sieve. In this embodiment, a crucible made of aluminum oxide (also referred to as alumina) with a purity of 99.9% is used. It is preferable that the material subjected to heating be collected after the material is transferred from the crucible to the mortar because impurities are prevented from mixing into the material. The mortar is preferably made of a material that is less likely to release impurities. Specifically, it is preferable to use a mortar made of alumina with a purity of 90% or higher, preferably 99% or higher.

Next, the second heating is performed. As a firing device used for the second heating, an electric furnace such as rotary kiln can be used.

The second heating temperature is at least higher than the first heating temperature, and preferably higher than 700° C. and lower than or equal to 1050° C. The time of the second heating is preferably longer than or equal to one hour and shorter than or equal to 20 hours. The second heating is preferably performed in an oxygen atmosphere, and in particular, preferably performed while oxygen is supplied. For example, the flow rate is 10 L/min. per inner capacity 1 L of the furnace. Specifically, the heating is preferably performed while a container containing the mixture 903 is covered with a lid.

Then, grinding or crushing is performed with a mortar to loosen the secondary particles fixed one another, and the ground or crushed mixture is collected. Furthermore, classification may be performed using a sieve.

Through the above steps, the positive electrode active material 200A can be formed. The positive electrode active material 200A obtained through the above steps is NCM to which Al is added, and thus called NCMA in some cases.

### Embodiment 2

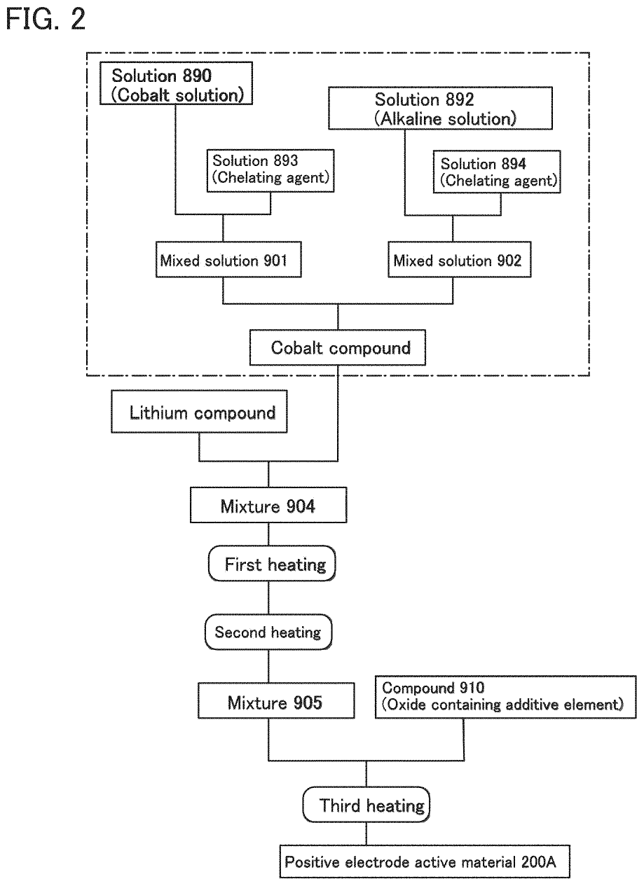

Embodiment 1 shows an example in which a lithium compound and a compound that is an oxide containing an additive element are mixed into a cobalt compound obtained by a coprecipitation method, and this embodiment shows, using FIG. 2, an example in which a lithium compound is mixed into a cobalt compound obtained by a coprecipitation method, the mixture is subjected to heat treatment to form a mixture 905, and the mixture 905 and the compound 910 are mixed.

Note that the procedure up to the step of obtaining the cobalt compound by a coprecipitation method is the same as that described in Embodiment 1; thus, detailed description thereof is omitted here.

In this embodiment, the cobalt compound and the lithium compound are weighed out to have desired amounts and mixed to form a mixture 904.

Next, the first heating is performed. As a firing device used for the first heating, an electric furnace such as rotary kiln can be used.

Next, second heating is performed to obtain the mixture 905. As a firing device used for the second heating, an electric furnace such as rotary kiln can be used.

The second heating temperature is at least higher than the first heating temperature, and preferably higher than 700° C. and lower than or equal to 1050° C. The time of the second heating is preferably longer than or equal to one hour and shorter than or equal to 20 hours. The second heating is preferably performed in an oxygen atmosphere, and in particular, preferably performed while oxygen is supplied. For example, the flow rate is 10 L/min. per inner capacity 1 L of the furnace. Specifically, the heating is preferably performed while a container containing the mixture 904 is covered with a lid.

Then, grinding or crushing is performed with a mortar to loosen the secondary particles fixed one another, and the ground or crushed mixture secondary is collected. Furthermore, classification may be performed using a sieve.

Then, the obtained mixture 905 and the compound 910 are mixed. As the compound 910, one or more selected from aluminum oxide, aluminum hydroxide, magnesium oxide, magnesium hydroxide, basic magnesium carbonate ((MgCO₃)₃Mg(OH)₂.3H₂O), calcium oxide, calcium carbonate, and calcium hydroxide are used. An aluminum salt is used as the additive element source and aluminum hydroxide (Al(OH)₃) is used as the compound 910. The compound 910 used as the additive element source is weighed out to be contained with a desired amount by a practitioner in consideration of the compositions of the lithium compound and the cobalt compound.

Then, the third heating is performed. The third heating temperature is at least higher than the first heating temperature, and preferably higher than 700° C. and lower than or equal to 1050° C. The time of the third heating is shorter than that of the second heating, and preferably longer than or equal to one hour and shorter than or equal to 20 hours. The third heating is preferably performed in an oxygen atmosphere, and in particular, preferably performed while oxygen is supplied. For example, the flow rate is 10 L/min. per inner capacity 1 L of the furnace. Specifically, the heating is preferably performed while a container containing the mixture 905 is covered with a lid.

Then, grinding or crushing is performed with a mortar to loosen the secondary particles fixed one another, and the ground or crushed mixture is collected. Furthermore, classification may be performed using a sieve.

Through the above steps, the positive electrode active material 200A can be formed. Although the same reference numeral 200A is used for the positive electrode active materials in this embodiment and Embodiment 1, the processes therefor are partly different; therefore, the composition of the positive electrode active material 200A may be different between this embodiment and Embodiment 1.

### Embodiment 3

In this embodiment, nickel sulfate, cobalt sulfate, and manganese sulfate are weighed out to have desired amounts and mixed. The mixed solution 901 obtained by mixing the aqueous solution 890 containing these to the aqueous solution 893, the mixed solution 902 obtained by mixing the aqueous solution 892, which is an alkaline solution, and the aqueous solution 894, and a mixed solution 906 obtained by mixing an aqueous solution 896 containing an additive element and an aqueous solution 895 are prepared. The aqueous solutions 893, 894, 895 are, but not particularly limited to, aqueous solutions serving as a chelating agent, and may be pure water.

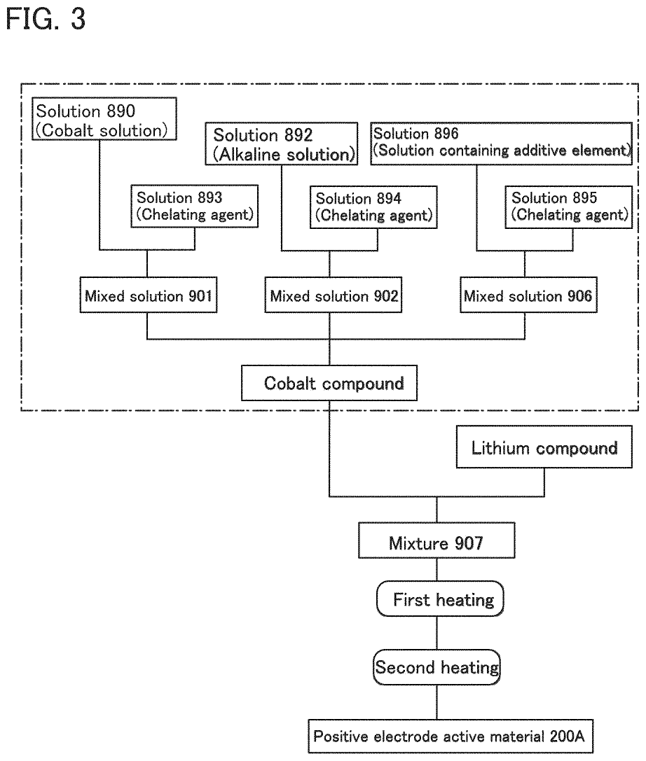

In FIG. 3, the aqueous solution 896 containing an additive element is further used as a material for forming a cobalt compound by a coprecipitation method. In the case where aluminum is added as an additive element, an aluminum aqueous solution is further supplied to the reaction tank. In the case where aluminum is added as an additive element, an aqueous solution containing aluminum is further supplied to the reaction tank. In the case where magnesium is added as an additive element to the mixture, an aqueous solution containing magnesium is further supplied to the reaction tank. In the case where calcium is added as an additive element to the mixture, an aqueous solution containing calcium is further supplied to the reaction tank.

The pH inside the reaction tank is preferably greater than or equal to 9.0 and less than or equal to 11.0, more preferably greater than or equal to 10.0 and less than or equal to 10.5.

Note that the process after the step of forming the cobalt compound by a coprecipitation method is the same as that in Embodiment 1; thus, detailed description thereof is omitted here.

As shown in FIG. 3, the cobalt compound obtained by a coprecipitation method and the lithium compound are mixed to form a mixture 907.

After the mixture 907 is obtained, the first heating is performed. As a firing device used for the first heating, an electric furnace such as rotary kiln can be used.

Next, the second heating is performed. As a firing device used for the second heating, an electric furnace such as rotary kiln can be used.

The second heating temperature is at least higher than the first heating temperature, and preferably higher than 700° C. and lower than or equal to 1050° C. The time of the second heating is preferably longer than or equal to one hour and shorter than or equal to 20 hours. The second heating is preferably performed in an oxygen atmosphere, and in particular, preferably performed while oxygen is supplied. For example, the flow rate is 10 L/min. per inner capacity 1 L of the furnace. Specifically, the heating is preferably performed while a container containing the mixture 907 is covered with a lid.

Then, grinding or crushing is performed with a mortar to loosen the secondary particles fixed one another, and the ground or crushed mixture is collected. Furthermore, classification may be performed using a sieve.

Through the above steps, the positive electrode active material 200A can be formed. Although the same reference numeral 200A is used for the positive electrode active materials in this embodiment and Embodiment 1, the processes therefor are partly different; therefore, the composition of the positive electrode active material 200A may be different between this embodiment and Embodiment 1.

The process flow in this embodiment is not limited to that shown in FIG. 3.

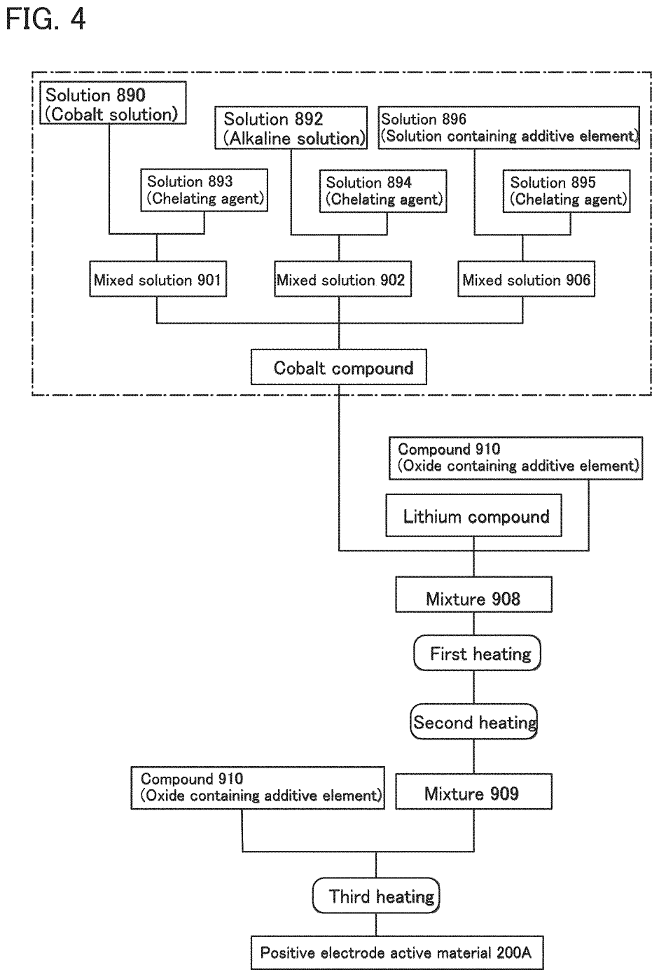

FIG. 4 shows a process flow that is a modification example of FIG. 3.

The process until the cobalt compound is obtained by a coprecipitation method in FIG. 4 is the same as that shown in FIG. 3. After that, second mixing of an additive element, two times heating, and third mixing of an additive element are performed in the example of FIG. 4.

In FIG. 4, after the cobalt compound is obtained as in the case of FIG. 3, the cobalt compound, a lithium compound, and the compound 910 are mixed to form a mixture 908.

After the mixture 908 is obtained, the first heating is performed. As a firing device used for the first heating, an electric furnace such as rotary kiln can be used.

Next, the second heating is performed. As a firing device used for the second heating, an electric furnace such as rotary kiln can be used.

The second heating temperature is at least higher than the first heating temperature, and preferably higher than 700° C. and lower than or equal to 1050° C. The time of the second heating is preferably longer than or equal to one hour and shorter than or equal to 20 hours. The second heating is preferably performed in an oxygen atmosphere, and in particular, preferably performed while oxygen is supplied. For example, the flow rate is 10 L/min. per inner capacity 1 L of the furnace. Specifically, the heating is preferably performed while a container containing the mixture 908 is covered with a lid.

Then, grinding or crushing is performed with a mortar to loosen the secondary particles fixed one another, and the ground or crushed mixture is collected. Furthermore, classification may be performed using a sieve.

Then, the obtained mixture 909 and the compound 910 are mixed.

Then, the third heating is performed. The third heating temperature is at least higher than the first heating temperature, and preferably higher than 700° C. and lower than or equal to 1050° C. The time of the third heating is preferably longer than or equal to one hour and shorter than or equal to 20 hours. The third heating is preferably performed in an oxygen atmosphere, and in particular, preferably performed while oxygen is supplied. For example, the flow rate is 10 L/min. per inner capacity 1 L of the furnace. Specifically, the heating is preferably performed while a container containing the mixture 909 is covered with a lid.

Then, grinding or crushing is performed with a mortar to loosen the secondary particles fixed one another, and the ground or crushed mixture is collected. Furthermore, classification may be performed using a sieve.

Through the above steps, the positive electrode active material 200A can be formed. Although the same reference numeral 200A is used for the positive electrode active materials in FIG. 3 and FIG. 4, the processes therefor are partly different; therefore, the composition of the positive electrode active material 200A may be different between the formation flows in FIG. 3 and FIG. 4.

FIG. 4 shows an example in which mixing of an additive element is performed three times, but one embodiment of the present invention is not particularly limited to this. The number of times of mixing an additive element may be one or plural. Alternatively, different kinds of additive elements may be used in combination. When the formation flow in FIG. 4 is used, three kinds of additive elements can be added to the positive electrode active material 200A.

This embodiment can be freely combined with any of the other embodiments.

### Embodiment 4

In this embodiment, a coprecipitation apparatus that performs a coprecipitation method in the formation method described in Embodiments 1 to 3 is described.

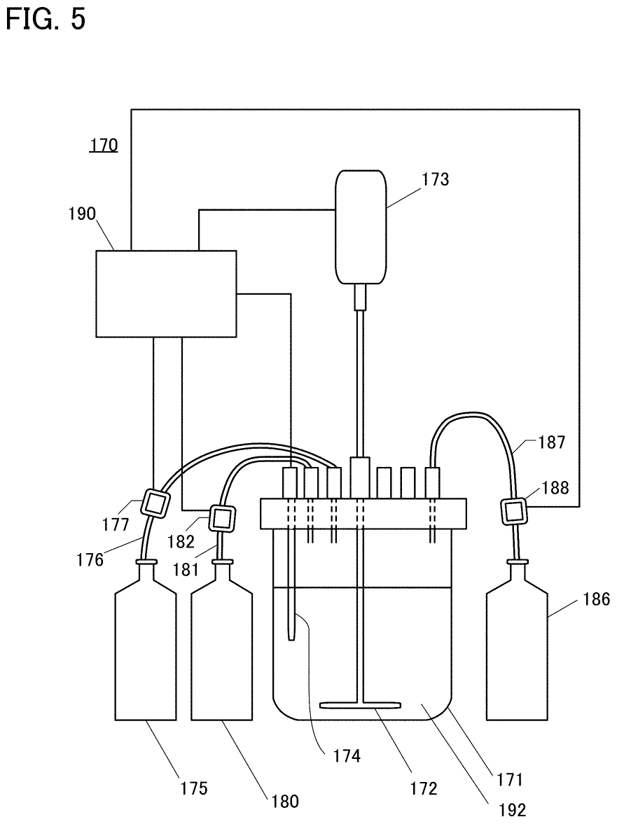

A synthesis apparatus 170 shown in FIG. 5 includes a reaction tank 171, and the reaction tank 171 includes a reaction container. A separable flask may be used in a lower portion of the reaction container and a separable cover may be used in an upper portion. The separable flask may be a cylindrical type or a round type. A cylindrical separable flask has a flat bottom. The atmosphere in the reaction tank 171 can be controlled through at least one inlet of the separable cover. For example, the atmosphere preferably contains nitrogen. In that case, it is preferable to make nitrogen flow in the reaction tank 171. Nitrogen is preferably subjected to bubbling in an aqueous solution 192 in the reaction tank 171. The synthesis apparatus 170 may include a reflux condenser connected to at least one inlet of the separable cover. This reflux condenser allows an atmosphere gas in the reaction tank 171, e.g., nitrogen, to be ejected and water to return to the reaction tank 171. An amount of airflow necessary for ejecting a gas generated by a thermal decomposition reaction caused by heat treatment may flow as an atmosphere in the reaction tank 171.

The steps of a coprecipitation method surrounded by the chain line in FIG. 1 are described with reference to FIG. 1 and FIG. 5.

First, the aqueous solution 894 (a chelating agent) is put in the reaction tank 171, and then the mixed solution 901 and the aqueous solution 892 (an alkaline solution) are dropped into the reaction tank 171. The aqueous solution 192 in FIG. 5 is in the state where dropping has started. Note that the aqueous solution 894 is sometimes referred to as a filling liquid. In some cases, the filling liquid is referred to as an adjusting liquid, and referred to as an aqueous solution before reaction, that is, an aqueous solution in an initial state.

Other components of the synthesis apparatus 170 shown in FIG. 5 are described. The synthesis apparatus 170 includes a stirrer 172, a stirrer motor 173, a thermometer 174, a tank 175, a tube 176, a pump 177, a tank 180, a tube 181, a pump 182, a tank 186, a tube 187, a pump 188, and a control device 190.

The stirrer 172 can stir the aqueous solution 192 in the reaction tank 171, and the stirrer motor 173 is included as a power source that makes the stirrer 172 rotate. The stirrer 172 includes a paddle-type agitator blade (denoted as a paddle blade), and the paddle blade includes two to six blades. The blade may have an inclination of greater than or equal to 40° and less than or equal to 70°.

The thermometer 174 can measure the temperature of the aqueous solution 192. The temperature of the reaction tank 171 can be controlled using a thermoelectric element such that the temperature of the aqueous solution 192 is constant. An example of the thermoelectric element is a Peltier element. Although not shown, a pH meter is also provided in the reaction tank 171, and the pH of the aqueous solution 192 can be measured.

The tanks can store different raw material aqueous solutions. For example, the tanks can be filled with the mixed solution 901 and the aqueous solution 892. A tank filled with the aqueous solution 894 serving as a filling liquid may be prepared. A pump is provided for each tank, and with the use of the pump, the raw material aqueous solution can be dropped into the reaction tank 171 through a tube. The amount of the raw material aqueous solution to be dropped, i.e., the solution sending amount can be controlled by the pump. In addition to the pump, a valve may be provided for the tube 176, and the amount of the raw material aqueous solution to be dropped, i.e., the solution sending amount may be controlled with the valve.

The control device 190 is electrically connected to the stirrer motor 173, the thermometer 174, the pump 177, the pump 182, and the pump 188, and can control the number of rotations of the stirrer 172, the temperature of the aqueous solution 192, and the amount of each raw material aqueous solution to be dropped.

The number of rotations of the stirrer 172, specifically, the number of rotations of the paddle blade is preferably, for example, greater than or equal to 800 rpm and less than or equal to 1200 rpm. The stirring is preferably performed while the aqueous solution 192 is heated at a temperature higher than or equal to 50° C. and lower than or equal to 90° C. In that case, the mixed solution 901 is preferably dropped into the reaction tank 171 at a constant rate. The number of rotations of the paddle blade is not limited to a constant number and can be adjusted as appropriate. For example, the number of rotations can be changed in accordance with the amount of liquid in the reaction tank 171. Moreover, the dropping rate of the mixed solution 901 can be adjusted. The dropping rate is preferably adjusted in order to keep the pH in the reaction tank 171 constant. The dropping rates may be controlled so that the aqueous solution 892 is dropped when the pH in the reaction tank 171 is changed from a desired pH value during dropping of the mixed solution 901. The pH value is greater than or equal to 9.0 and less than or equal to 11.0, preferably greater than or equal to 9.8 and less than or equal to 10.3.

Through the above process, a reaction product precipitates in the reaction tank 171. The reaction product includes a cobalt compound. This reaction can be called coprecipitation, and the process is called a coprecipitation process in some cases.

This embodiment can be freely combined with any of the other embodiments.

### Embodiment 5

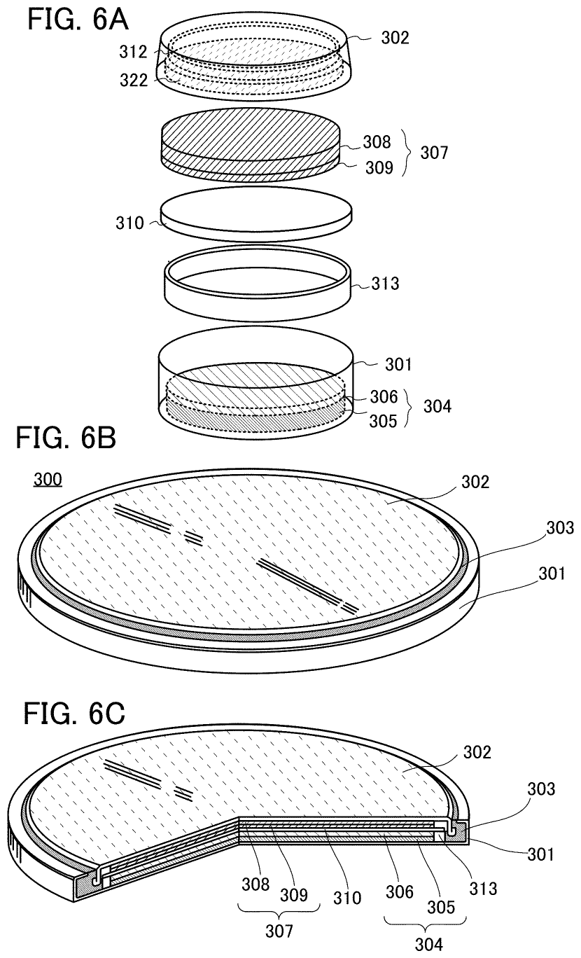

An example of a coin-type secondary battery is described. FIG. 6A, FIG. 6B, and FIG. 6C are an exploded perspective view, an external view, and a cross-sectional view of a coin-type (single-layer flat) secondary battery. Coin-type secondary batteries are mainly used in small electronic devices. In this specification, coin-type batteries include button-type batteries.

For easy understanding, FIG. 6A is a schematic view showing overlap (a vertical relation and a positional relation) between components. Thus, FIG. 6A and FIG. 6B do not completely correspond with each other.

In FIG. 6A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 6A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 is a stack in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 6B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel and aluminum in order to prevent corrosion due to the electrolyte solution, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 6C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured.

The coin-type secondary battery 300 can have high capacity, high charge and discharge capacity, and excellent cycle performance. Note that in the case where the coin-type secondary battery 300 is an all-solid-state battery, the separator 310 between the negative electrode 307 and the positive electrode 304 can be omitted.

### [Cylindrical Secondary Battery]

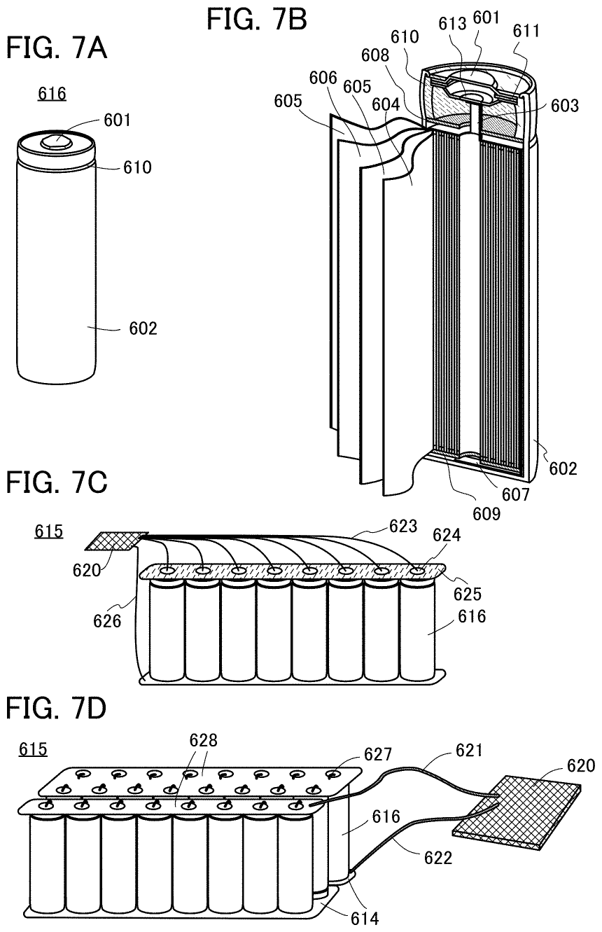

An example of a cylindrical secondary battery is described with reference to FIG. 7A. As illustrated in FIG. 7A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 7B schematically illustrates a cross section of a cylindrical secondary battery. The cylindrical secondary battery illustrated in FIG. 7B includes the positive electrode cap (battery cap) 601 on the top surface and the battery can (outer can) 602 on the side and bottom surfaces. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is close and the other end thereof is open. For the battery can 602, a metal having corrosion resistance to an electrolyte solution typified by nickel, aluminum, or titanium, an alloy of such a metal, or an alloy of such a metal and another metal (e.g., stainless steel) can be used. The battery can 602 is preferably covered with nickel and aluminum in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors. Although FIGS. 7A to 7D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 200A shown in Embodiment 1 is used in the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material of aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic can be used for the PTC element.

FIG. 7C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used.

FIG. 7D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series. Alternatively, the plurality of secondary batteries 616 may be connected in parallel and then connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 7D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### Other Structure Examples of Secondary Battery

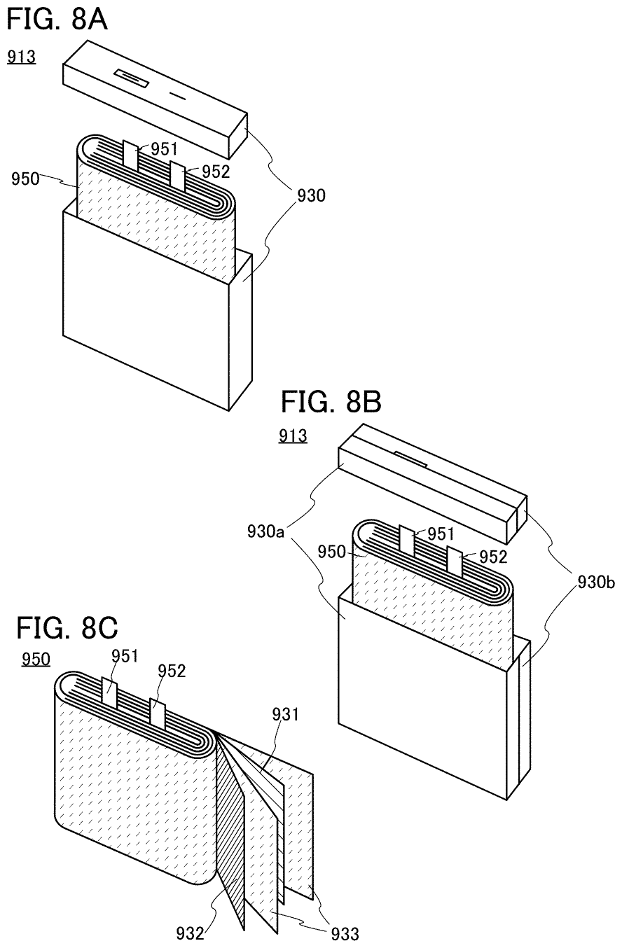

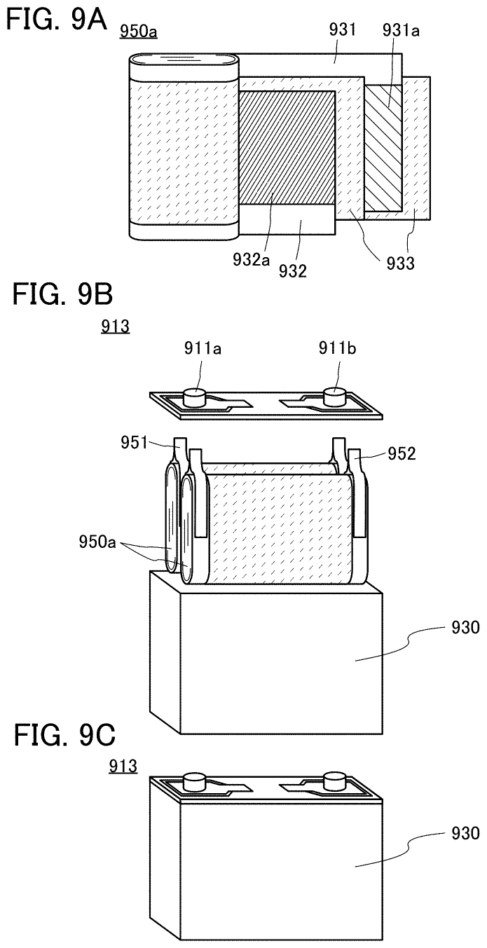

Structure examples of secondary batteries are described with reference to FIGS. 8A to 8C and FIGS. 9A to 9C.

A secondary battery 913 illustrated in FIG. 8A includes a wound body 950 provided with a terminal 951 and a terminal 952 inside a housing 930. The wound body 950 is immersed in an electrolyte solution inside the housing 930. The terminal 952 is in contact with the housing 930. The use of an insulator inhibits contact between the terminal 951 and the housing 930. Note that in FIG. 8A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 8B, the housing 930 in FIG. 8A may be formed using a plurality of materials. For example, in the secondary battery 913 in FIG. 8B, a housing 930a and a housing 930b are attached to each other, and the wound body 950 is provided in a region surrounded by the housing 930a and the housing 930b.

For the housing 930a, an insulating material typified by an organic resin can be used. In particular, when an insulating material typified by an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 8C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIGS. 9A to 9C, the secondary battery 913 may include a wound body 950a. The wound body 950a illustrated in FIG. 9A includes the negative electrode 931, the positive electrode 932, and the separators 933. The negative electrode 931 includes a negative electrode active material layer 931a. The positive electrode 932 includes a positive electrode active material layer 932a.

The positive electrode active material 200A shown in Embodiment 1 is used in the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 9B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 9C, the wound body 950a and an electrolyte solution are covered with the housing 930, whereby the secondary battery 913 is completed. The housing 930 is preferably provided with a safety valve and an overcurrent protection element. A safety valve is a valve to be released by a predetermined internal pressure of the housing 930 in order to prevent the battery from exploding.

As illustrated in FIG. 9B, the secondary battery 913 may include a plurality of wound bodies 950a. The use of the plurality of wound bodies 950a enables the secondary battery 913 to have higher charge and discharge capacity. The description of the secondary battery 913 in FIGS. 8A to 8C can be referred to for the other components of the secondary battery 913 in FIGS. 9A and 9B.

### <Laminated Secondary Battery>

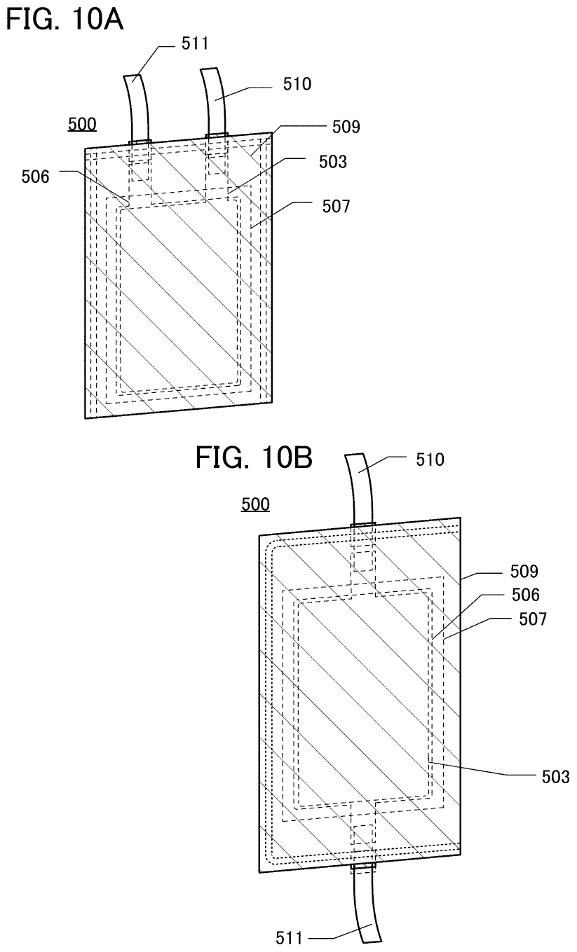

Next, examples of the appearance of a laminated secondary battery are shown in FIGS. 10A and 10B. FIGS. 10A and 10B each illustrate a positive electrode 503, a negative electrode 506, a separator 507, an exterior body 509, a positive electrode lead electrode 510, and a negative electrode lead electrode 511.

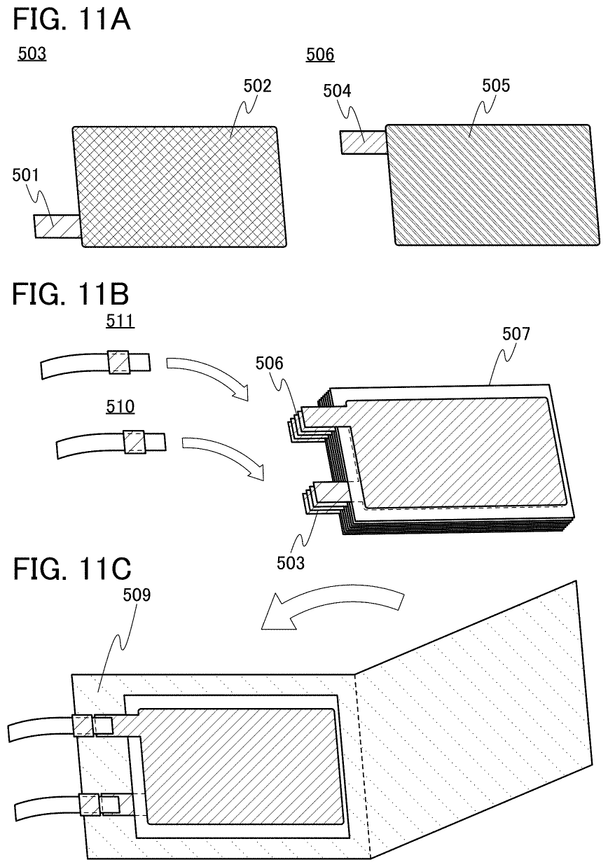

FIG. 11A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 11A.

### <Method for Manufacturing Laminated Secondary Battery>

Here, an example of a method for manufacturing the laminated secondary battery having the appearance illustrated in FIG. 10A will be described with reference to FIGS. 11B and 11C.

First, the negative electrode 506, the separator 507, and the positive electrode 503 are stacked. FIG. 11B illustrates the negative electrodes 506, the separators 507, and the positive electrodes 503 that are stacked. The secondary battery described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 11C. Then, the outer edges of the exterior body 509 are bonded to each other. The bonding can be performed by thermocompression. At this time, a part (or one side) of the exterior body 509 is left unbonded (to provide an inlet) so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

The positive electrode active material 200A shown in Embodiment 1 is used in the positive electrodes 503, whereby the secondary battery 500 can have high capacity, high charge and discharge capacity, and excellent cycle performance.

### Examples of Battery Pack

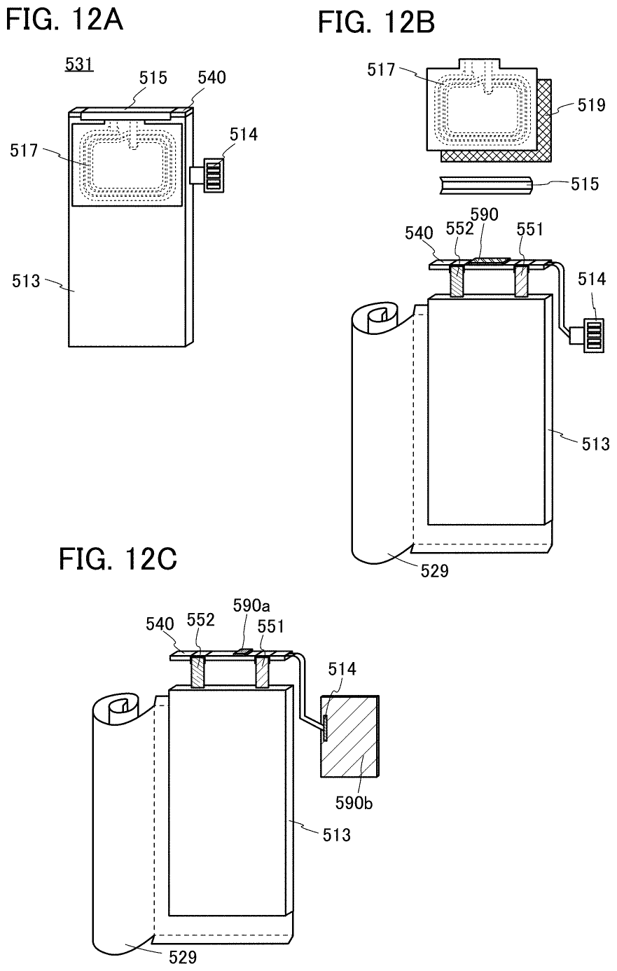

Examples of a secondary battery pack of one embodiment of the present invention that is capable of wireless charging using an antenna will be described with reference to FIGS. 12A to 12C.

FIG. 12A illustrates the appearance of a secondary battery pack 531 that has a rectangular solid shape with a small thickness (also referred to as a flat plate shape with a certain thickness). FIG. 12B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

As for the internal structure of the secondary battery 513, the secondary battery 513 may include a wound body or a stack.

In the secondary battery pack 531, a control circuit 590 is provided over the circuit board 540 as illustrated in FIG. 12B, for example. The circuit board 540 is electrically connected to a terminal 514. Moreover, the circuit board 540 is electrically connected to the antenna 517 and a positive electrode lead and a negative electrode lead 551 and 552 of the secondary battery 513.

Alternatively, as illustrated in FIG. 12C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, an antenna typified by a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents in this embodiment can be freely combined with the contents in any of the other embodiments.

### Embodiment 6

This embodiment will describe an example where an all-solid-state battery is manufactured using the positive electrode active material 200A shown in Embodiment 1.

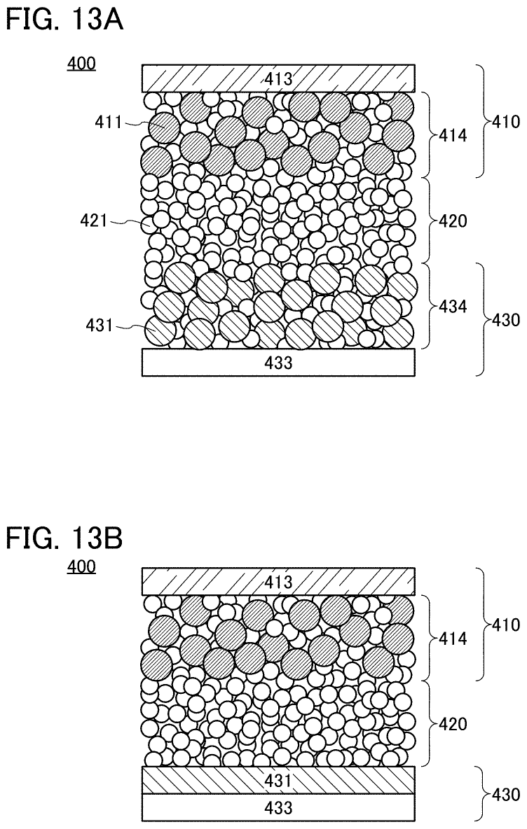

As illustrated in FIG. 13A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 200A shown in Embodiment 1 is used as the positive electrode active material 411. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive additive and a binder. Note that when metallic lithium is used as the negative electrode active material 431, metallic lithium does not need to be processed into particles; thus, the negative electrode 430 that does not include the solid electrolyte 421 can be formed, as illustrated in FIG. 13B. FIG. 13B shows an example in which the negative electrode active material 431 is deposited by a sputtering method. The use of metallic lithium for the negative electrode 430 is preferable, in which case the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S₃.44LiI, 63Li₂S.36SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃xTiO₃), a material with a NASICON crystal structure (e.g., Li_{1-y}Al_{y}Ti_{2-y}(PO₄)₃), a material with a garnet crystal structure (e.g., La₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0≤x≤1) having a NASICON crystal structure (hereinafter LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification, a material having a NASICON crystal structure refers to a compound that is represented by M₂(XO₄)₃ (M: transition metal; X: S, P, As, Mo, or W) and has a structure in which MO₆ octahedra and XO₄ tetrahedra that share common corners are arranged three-dimensionally.

### [Exterior Body and Shape of Secondary Battery]

An exterior body of the secondary battery 400 of one embodiment of the present invention can employ a variety of materials and have a variety of shapes, and preferably has a function of applying pressure to the positive electrode, the solid electrolyte layer, and the negative electrode.

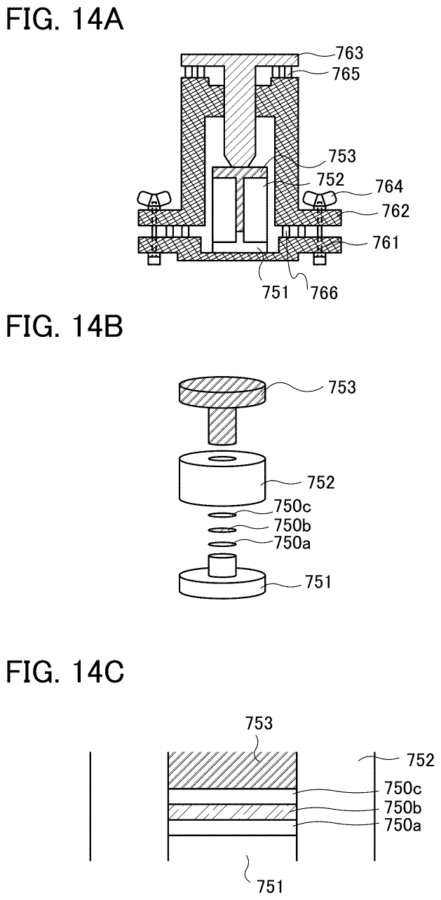

FIGS. 14A to 14C show an example of a cell for evaluating materials of an all-solid-state battery.

FIG. 14A is a schematic cross-sectional view of the evaluation cell. The evaluation cell includes a lower component 761, an upper component 762, and a fixation screw/butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 14B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 14C. Note that the same portions in FIGS. 14A to 14C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

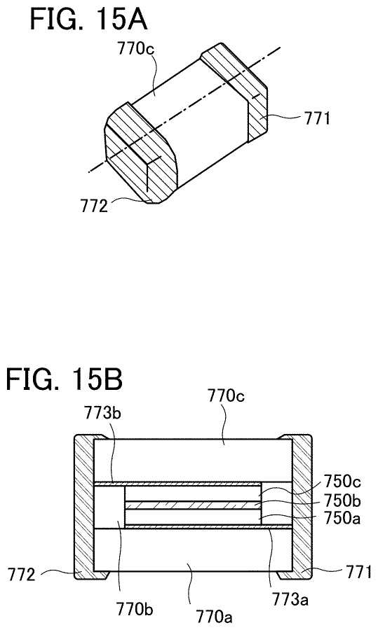

FIG. 15A is a perspective view of a secondary battery of one embodiment of the present invention that has an exterior body and a shape different from those in FIGS. 14A to 14C. The secondary battery in FIG. 15A includes external electrodes 771 and 772 and is sealed with an exterior body including a plurality of package components.

FIG. 15B illustrates an example of a cross section along the dashed-dotted line in FIG. 15A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 200A shown in Embodiment 1 achieves an all-solid-state secondary battery having a high energy density and favorable output characteristics.

The contents in this embodiment can be combined with the contents in any of the other embodiments as appropriate.

### Embodiment 7

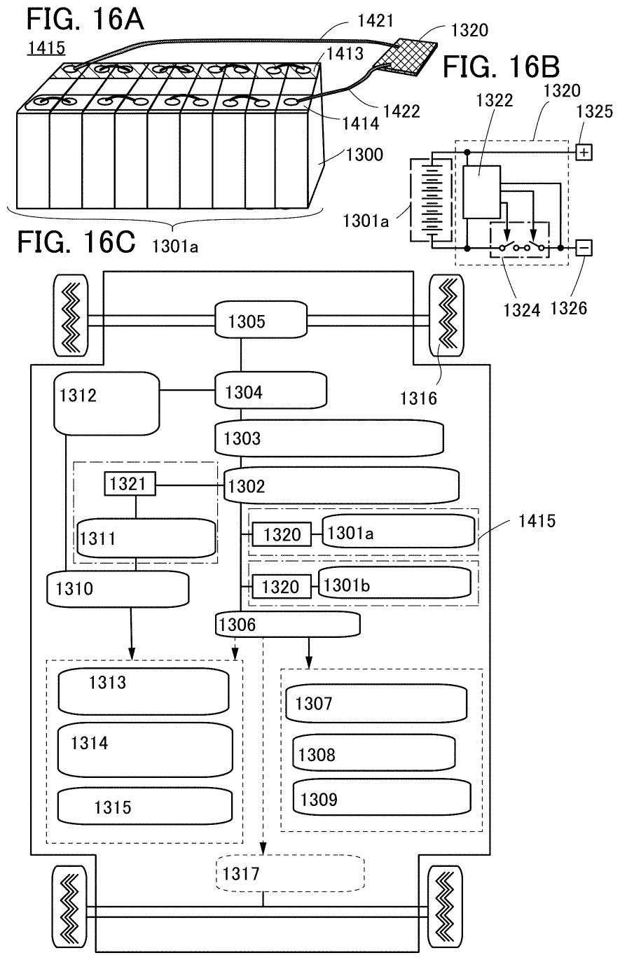

An example which is different from the cylindrical secondary battery in FIG. 7D is described in this embodiment. An example in which the present invention is applied to an electric vehicle (EV) is described with reference to FIG. 16C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery and a starter battery. The second battery 1311 specifically needs high output and does not necessarily have high capacity, and the capacity of the second battery 1311 is lower than that of the first batteries 1301a and 1301b.

The internal structure of the first battery 1301a may be the wound structure illustrated in FIG. 8A or FIG. 9C or the stacked structure illustrated in FIG. 10A or FIG. 10B. Alternatively, the first battery 1301a may be the all-solid-state battery in Embodiment 5. Using the all-solid-state battery in Embodiment 5 as the first battery 1301a achieves high capacity, a high degree of safety, and reduction in size and weight.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14V (such as an audio 1313, a power window 1314, and a lamp 1315) through a DC-DC circuit 1310.

The first battery 1301a is described with reference to FIG. 16A.

FIG. 16A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows an example in which the secondary batteries are fixed by the fixing portions 1413 and 1414, they may be stored in a battery container box (also referred to as a housing). Since a vibration or a jolt is assumed to be given to the vehicle from the outside (a road surface), the plurality of secondary batteries are preferably fixed by the fixing portions 1413 and 1414 and a battery container box. Furthermore, the one electrode of each battery is electrically connected to a control circuit portion 1320 through a wiring 1421. The other electrode of each battery is electrically connected to the control circuit portion 1320 through a wiring 1422.

FIG. 16B shows an example of a block diagram of the battery pack 1415 illustrated in FIG. 16A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, and the upper limit of output current to the outside. The range from the lower limit voltage to the upper limit voltage of the secondary battery falls within the recommended voltage range. When a voltage falls outside the range, the switch portion 1324 operates and functions as a protection circuit.

The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), or gallium oxide (GaOₓ, where x is a real number greater than 0).

The first batteries 1301a and 1301b mainly supply electric power to in-vehicle parts for 42 V (for a high-voltage system), and the second battery 1311 supplies electric power to in-vehicle parts for 14 V (for a low-voltage system). A lead battery is usually used for the second battery 1311 due to cost advantage.

In this embodiment, an example in which a lithium-ion secondary battery is used as both the first battery 1301a and the second battery 1311 is described. As the second battery 1311, a lead storage battery, an all-solid-state battery, or an electric double layer capacitor may alternatively be used. For example, the all-solid-state battery in Embodiment 3 may be used. Using the all-solid-state battery in Embodiment 3 as the second battery 1311 achieves high capacity, a high degree of safety, and reduction in size and weight.

Regenerative energy generated by rolling of tires 1316 is transmitted to the motor 1304 through a gear 1305, and is stored in the second battery 1311 through a motor controller 1303, a battery controller 1302, and the control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charging with regenerative energy, the first batteries 1301a and 1301b are preferably capable of fast charging.

The battery controller 1302 can set the charging voltage and charge current of the first batteries 1301a and 1301b. The battery controller 1302 can set charge conditions in accordance with charging characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a plug of the charger or a connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charging stations have a 100 V outlet, a 200 V outlet, or a three-phase 200V outlet with 50 kW. Furthermore, charging can be performed by electric power supplied from external charging equipment with a contactless power feeding method.

For fast charging, secondary batteries that can withstand charging at high voltage have been desired to perform charging in a short time.

The above-described secondary battery in this embodiment uses the positive electrode active material 200A shown in Embodiment 1. Moreover, it is possible to achieve a secondary battery in which graphene is used as a conductive additive, the electrode layer is formed thick to suppress a reduction in capacity while increasing the loading amount, and the electrical characteristics are significantly improved in synergy with maintenance of high capacity. This secondary battery is particularly effectively used in a vehicle and can achieve a vehicle that has a long range, specifically a driving range per charge of 500 km or greater, without increasing the proportion of the weight of the secondary battery to the weight of the entire vehicle.

Specifically, in the secondary battery in this embodiment, the use of the positive electrode active material 200A shown in Embodiment 1 can increase the operating voltage, and the increase in charging voltage can increase the available capacity. Moreover, using the positive electrode active material 200A shown in Embodiment 1 in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any of FIG. 7D, FIG. 9C, and FIG. 16A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can have high capacity. Thus, the secondary battery of one embodiment of the present invention is suitable for reduction in size and weight and is preferably used in transport vehicles.

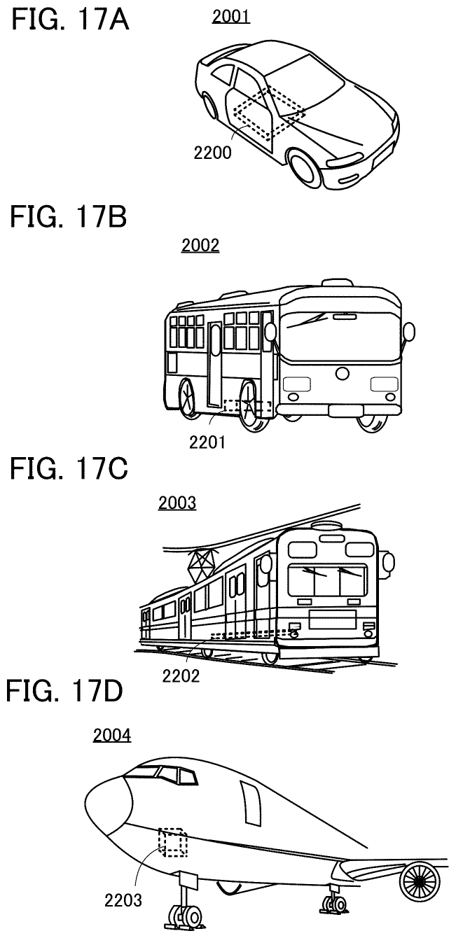

FIGS. 17A to 17D illustrate examples of transport vehicles using one embodiment of the present invention. An automobile 2001 illustrated in FIG. 17A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery exemplified in Embodiment 4 is provided at one position or several positions. The automobile 2001 illustrated in FIG. 17A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power through external charging equipment by a plug-in system or a contactless power feeding system. In charging, a given method such as CHAdeMO (registered trademark) or Combined Charging System can be employed as a charging method, the standard of a connector, and the like as appropriate. A charging device may be a charging station provided in a commerce facility or a power source in a house. For example, with the use of the plug-in technique, the power storage device mounted on the automobile 2001 can be charged by being supplied with electric power from outside. The charging can be performed by converting AC electric power into DC electric power through a converter typified by an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 17B illustrates a large transporter 2002 having a motor controlled by electricity as an example of a transport vehicle. A secondary battery module of the transporter 2002 includes a cell unit of four secondary batteries with a nominal voltage of 3.0 V or higher and 5.0 V or lower, for example, and 48 cells are connected in series to have a maximum voltage of 170 V. A battery pack 2201 has the same function as that in FIG. 17A except, for example, the number of secondary batteries configuring the secondary battery module; thus, the description is omitted.

FIG. 17C illustrates a large transportation vehicle 2003 having a motor controlled by electricity as an example. A secondary battery module of the transportation vehicle 2003 has more than 100 secondary batteries with a nominal voltage of 3.0 V or higher and 5.0 V or lower connected in series, and the maximum voltage is 600 V. With the use of the positive electrode using the positive electrode active material 200A shown in Embodiment 1, a secondary battery having favorable rate characteristics and charge and discharge cycle performance can be fabricated, which can contribute to higher performance and a longer life of the transport vehicle 2003. A battery pack 2202 has the same function as that in FIG. 17A except the number of secondary batteries configuring the secondary battery module; thus, the description is omitted.

FIG. 17D illustrates an aircraft 2004 having a combustion engine as an example. The aircraft 2004 illustrated in FIG. 17D is regarded as a transport vehicle because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 17A except, for example, the number of secondary batteries configuring the secondary battery module; thus, the description is omitted.

The contents in this embodiment can be combined with the contents in any of the other embodiments as appropriate.

### Embodiment 8

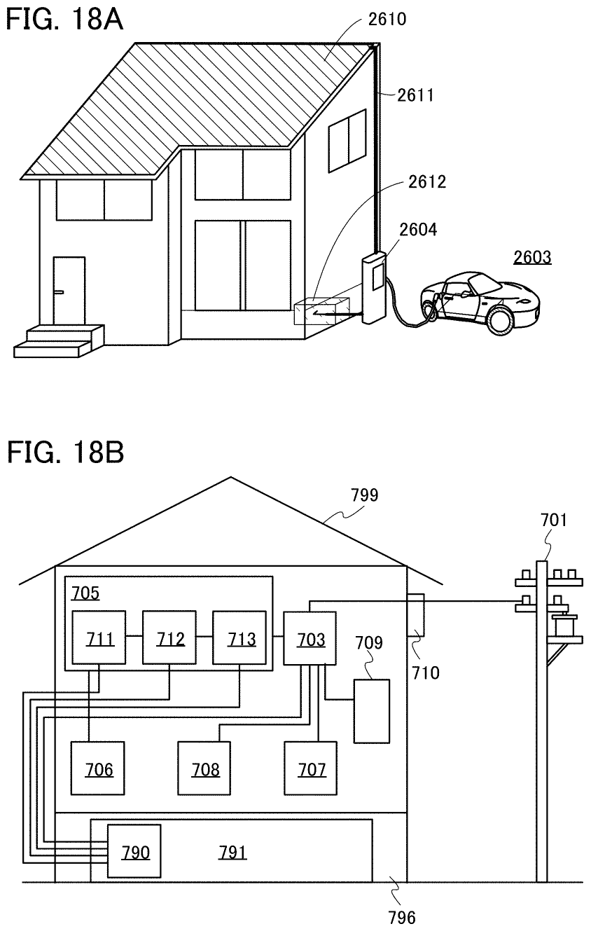

In this embodiment, examples in which the secondary battery of one embodiment of the present invention is mounted on a building will be described with reference to FIGS. 18A and 18B.

A house illustrated in FIG. 18A includes a power storage device 2612 including the secondary battery of one embodiment of the present invention and a solar panel 2610. The power storage device 2612 is electrically connected to the solar panel 2610 through a wiring 2611. The power storage device 2612 may be electrically connected to a ground-based charging device 2604. The power storage device 2612 can be charged with electric power generated by the solar panel 2610. A secondary battery included in a vehicle 2603 can be charged with the electric power stored in the power storage device 2612 through the charging device 2604. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, the electronic devices can be operated with the use of the power storage device 2612 of one embodiment of the present invention as an uninterruptible power source even when electric power cannot be supplied from the commercial power supply due to power failure.

FIG. 18B illustrates an example of a power storage device of one embodiment of the present invention. As illustrated in FIG. 18B, a power storage device 791 of one embodiment of the present invention is provided in an underfloor space 796 of a building 799. The power storage device 791 may be provided with the control circuit portion described in Embodiment 7, and the use of a secondary battery including a positive electrode using the positive electrode active material 200A shown in Embodiment 1 enables the power storage device 791 to have a long lifetime.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electrical device typified by a TV or a personal computer. The power storage load 708 is, for example, an electrical device typified by a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may also have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The indicator 706 can show the amount of electric power consumed by the general load 707 and the power storage load 708 that is measured by the measuring portion 711. An electrical device typified by a TV or a personal computer can also show it through the router 709. Furthermore, a portable electronic terminal typified by a smartphone or a tablet can also show it through the router 709. The indicator 706, the electrical device, and the portable electronic terminal can also show the demand for electric power depending on a time period (or per hour) that is predicted by the predicting portion 712.

The contents in this embodiment can be combined with the contents in any of the other embodiments as appropriate.

### Embodiment 9

This embodiment will describe examples in which the power storage device of one embodiment of the present invention is mounted on a motorcycle and a bicycle.

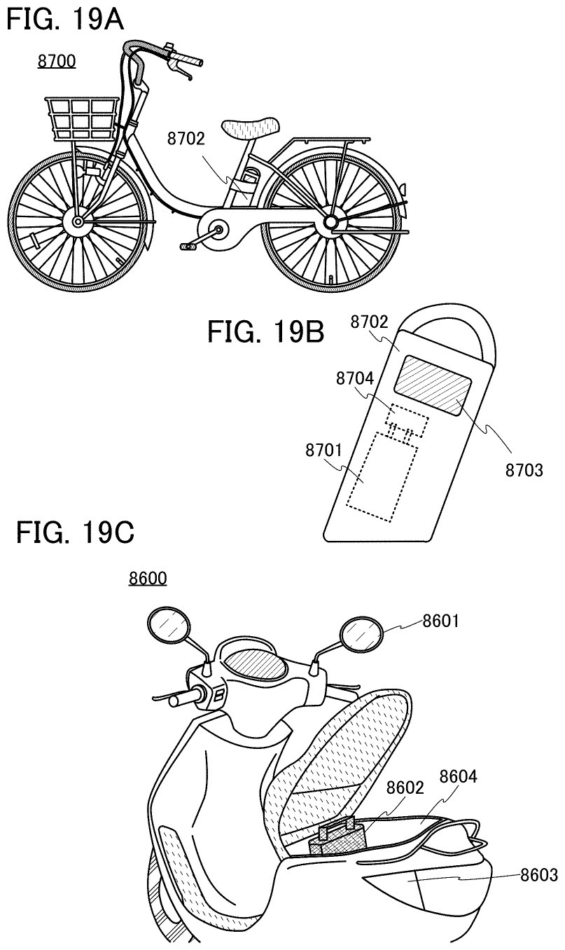

FIG. 19A illustrates an example of an electric bicycle using the power storage device of one embodiment of the present invention. The power storage device of one embodiment of the present invention can be used for an electric bicycle 8700 in FIG. 19A. The power storage device of one embodiment of the present invention includes a plurality of storage batteries and a protection circuit, for example.

The electric bicycle 8700 is provided with a power storage device 8702. The power storage device 8702 can supply electric power to a motor that assists a rider. The power storage device 8702 is portable, and FIG. 19B shows the state where the power storage device 8702 is removed from the electric bicycle. The power storage device 8702 incorporates a plurality of storage batteries 8701 included in the power storage device of one embodiment of the present invention, and can display the remaining battery level on a display portion 8703. The power storage device 8702 includes a control circuit portion 8704 capable of charge control or anomaly detection for the secondary battery, which is exemplified in Embodiment 7. The control circuit portion 8704 is electrically connected to a positive electrode and a negative electrode of the storage battery 8701. The control circuit portion 8704 may include the small solid-state secondary battery illustrated in FIGS. 15A and 15B. When the small solid-state secondary battery illustrated in FIGS. 15A and 15B is provided in the control circuit portion 8704, electric power can be supplied to store data in a memory circuit included in the control circuit portion 8704 for a long time. When the control circuit portion 8704 is used in combination with a secondary battery having a positive electrode using the positive electrode active material 200A shown in Embodiment 1, the synergy on safety can be obtained.

FIG. 19C illustrates an example of a motorcycle using the power storage device of one embodiment of the present invention. A motor scooter 8600 illustrated in FIG. 19C includes a power storage device 8602, side mirrors 8601, and indicators 8603. The power storage device 8602 can supply electric power to the indicators 8603. The power storage device 8602 including a plurality of secondary batteries having a positive electrode using the positive electrode active material 200A shown in Embodiment 1 can have high capacity and contribute to a reduction in size.

In the motor scooter 8600 illustrated in FIG. 19C, the power storage device 8602 can be held in an under-seat storage unit 8604. The power storage device 8602 can be held in the under-seat storage unit 8604 even with a small size.

The contents in this embodiment can be combined with the contents in any of the other embodiments as appropriate.

### Embodiment 10

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

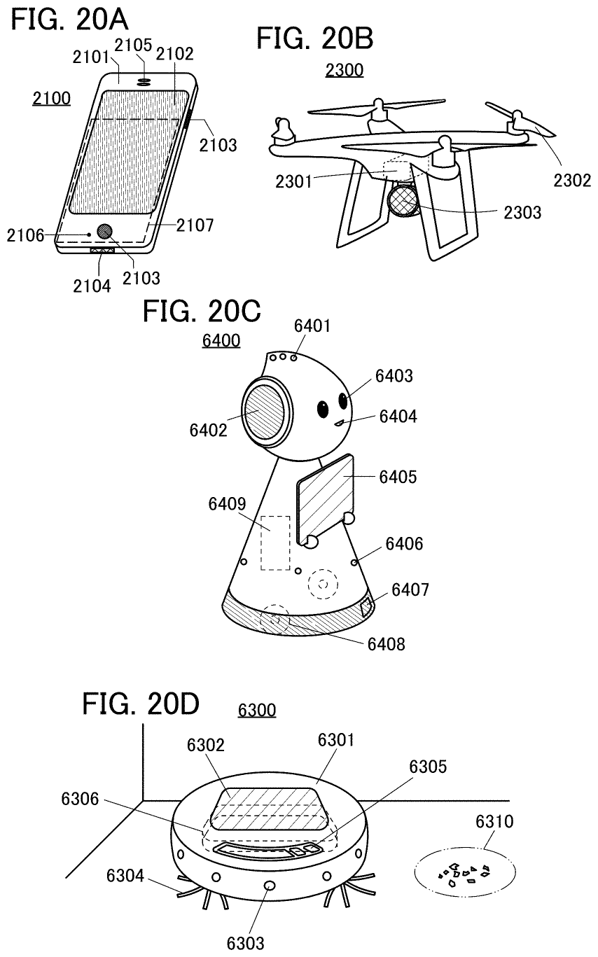

FIG. 20A illustrates an example of a mobile phone. A mobile phone 2100 includes a housing 2101 in which a display portion 2102 is incorporated, an operation button 2103, an external connection port 2104, a speaker 2105, and a microphone 2106. The mobile phone 2100 includes a secondary battery 2107. The use of the secondary battery 2107 having a positive electrode using the positive electrode active material 200A shown in Embodiment 1 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted.

FIG. 20B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 200A shown in Embodiment 1 has a high energy density and a high degree of safety, and thus can be used safely for a long time over a long period of time and is preferable as the secondary battery included in the unmanned aircraft 2300.

FIG. 20C illustrates an example of a robot. A robot 6400 illustrated in FIG. 20C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, and an arithmetic device.

The microphone 6402 has a function of detecting a speaking voice of a user and an environmental sound. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 200A shown in Embodiment 1 has a high energy density and a high degree of safety, and thus can be used safely for a long time over a long period of time and is preferable as the secondary battery 6409 included in the robot 6400.

FIG. 20D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, and a variety of sensors. Although not illustrated, the cleaning robot 6300 is provided with a tire, and an inlet. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the secondary battery 6306 of one embodiment of the present invention and a semiconductor device or an electronic component. A secondary battery including a positive electrode using the positive electrode active material 200A shown in Embodiment 1 has a high energy density and a high degree of safety, and thus can be used safely for a long time over a long period of time and is preferable as the secondary battery 6306 included in the cleaning robot 6300.

The contents in this embodiment can be combined with the contents in any of the other embodiments as appropriate.

### Example

In this example, the average crushing strength of the positive electrode active material obtained in accordance with Embodiment 1 was measured. The positive electrode active material obtained in accordance with Embodiment 1 is composed of a primary particle and a secondary particle formed by aggregation of the primary particles.

The average crushing strength is calculated in such a manner that test pressure (load) is applied to a particle arbitrarily selected and the displacement volume of the particle is measured with use of a microparticle compressive strength analyzer (nanoindenter). In this example, 10 particles were selected, measurement was performed, and then the obtained crushing strengths are subjected to arithmetic mean to obtain the average crushing strength. In this example, NS-A300 produced by Nano Seeds Corporation was used as the microparticle compressive strength analyzer.

A cobalt compound including nickel, cobalt, and manganese with an element ratio Ni:Co:Mn=8:1:1 was obtained by a coprecipitation method in accordance with Embodiment 1, and then lithium and aluminum were added. After lithium and aluminum were added and mixed, first heat treatment was performed at 500° C. for 10 hours, the temperature was returned to room temperature and crushing was performed, and then second heat treatment was performed at 800° C. for 10 hours. Note that NCMA was obtained by adding Al at 1 atomic % with respect to the total of nickel, manganese, cobalt, and oxygen.

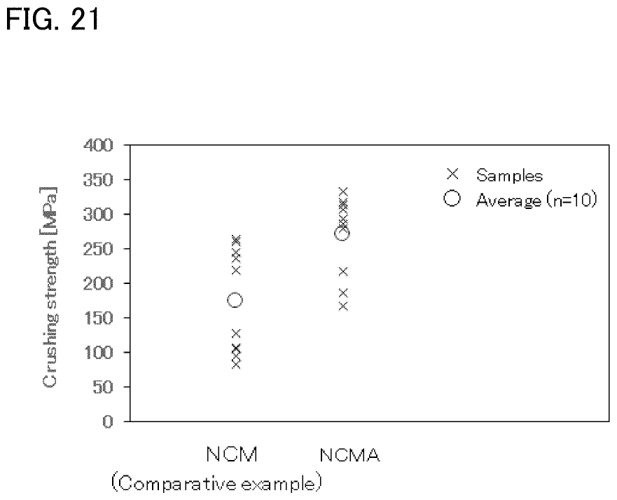

FIG. 21 shows measurement results of the microparticle compressive strength in this example. FIG. 21 shows 10 measurement values, and a circle shows the average value of the 10 measurement values.

FIG. 21 shows measurement results of a comparative example, NCM, which was obtained in the following manner: a cobalt compound including nickel, cobalt, and manganese with an element ratio Ni:Co:Mn=8:1:1 (also referred to as a nickel compound because the proportion of nickel is high) was obtained by the coprecipitation method in accordance with Embodiment 1; lithium is added and mixed; and heat treatment was performed at 800° C. for 10 hours. That is, heat treatment was performed only once for the comparative example. The average particle diameter of the comparative example (NCM) was 11 μm. The crushing strength of the comparative example (NCM) was in the range from 83.23 MPa to 263.29 MPa, and the average crushing strength was 174.32 MPa. Note that the average particle diameter (D50, also referred to as a median diameter) can be measured with a particle diameter distribution analyzer using a laser diffraction and scattering method or by observation with a SEM or a TEM. In this example, a laser diffraction particle size analyzer SALD-2200 produced by Shimadzu Corporation was used.

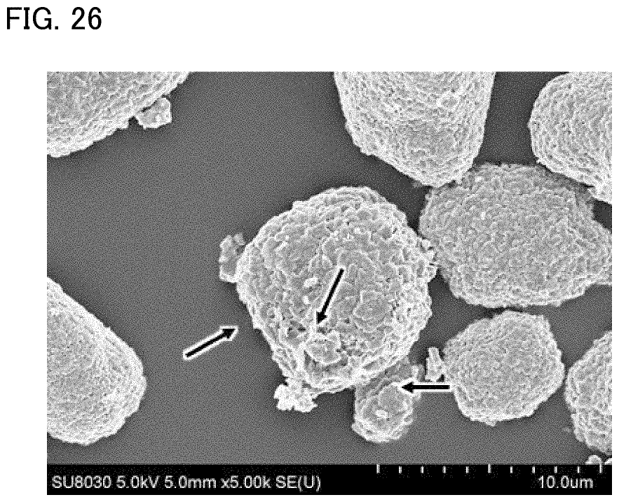

FIG. 26 shows the comparative example on which heat treatment (at 800° C. for 10 hours) was performed once. Arrows in FIG. 26 indicate portions which cannot be mixed well.

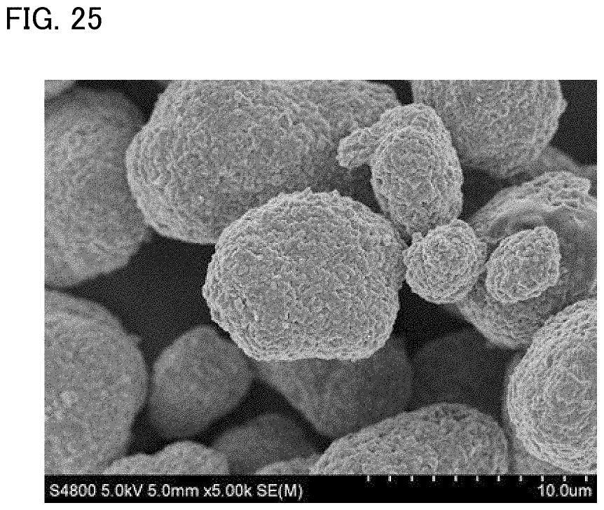

FIG. 25 is a SEM image of NCM obtained in the following manner: the cobalt compound including nickel, cobalt, and manganese with an element ratio Ni:Co:Mn=8:1:1 was obtained by a coprecipitation method in accordance with Embodiment 1; the compound was subjected to heat treatment twice (first heat treatment was performed at 500° C. for 10 hours, the temperature was returned to room temperature and crushing was performed, and then second heat treatment was performed at 800° C. for 10 hours). The secondary particle of NCM in FIG. 25 shows an example of a secondary particle which does not contain aluminum. It was confirmed that the mixing state in FIG. 25 was improved as compared with that of the comparative example in FIG. 26. This is probably because the heat treatment at 500° C. for 10 hours that was performed before the heat treatment at 800° C. for 10 hours can release moisture and the like contained in a precursor, which enabled uniform mixing.

The average particle diameter of this example (NCMA) was 9.3 μm. The crushing strength of this example was in the range from 166.5 MPa to 333.83 MPa and the average crushing strength thereof was 270.32 MPa. It was found that NCMA of this example has a higher average crushing strength than NCM of the comparative example.

It can be said that a positive electrode active material with high crushing strength has high particle strength. In the case where pressing is performed in a process of forming a positive electrode, particles are less likely to break. Furthermore, use of NCMA of this example as a positive electrode material of a secondary battery can prevent the secondary particle from being partially broken by expansion and contraction during charging and discharging. Accordingly, a positive electrode active material with high crushing strength can increase the capacity retention rate in a charging cycle.

In order to confirm the effect of increasing the capacity retention rate in the charging cycle, in this example, the positive electrode active material (NCMA) of one embodiment of the present invention was formed under the above-described conditions, a plurality of coin-type battery cells were fabricated, and the cycle characteristics of the cells were evaluated.

The positive electrode active material obtained by the method described in Embodiment 1 was used as positive electrode active materials of samples. Acetylene black was used as a conductive additive, the positive electrode active material and the conductive additive were mixed to form a slurry, and the slurry was applied to a current collector of aluminum.

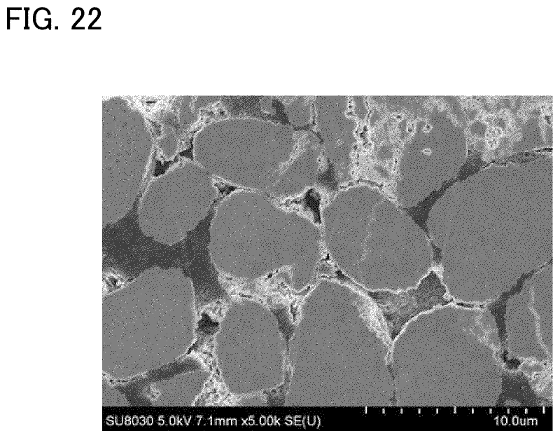

After the current collector was coated with the slurry, the solvent was volatilized. Then, pressure was applied at 210 kN/m and then at 1467 kN/m. Through the above steps, the positive electrode was obtained. In the positive electrode, the carried amount was approximately 7 mg/cm². FIG. 22 shows an observation photograph of a cross section of part of the positive electrode.

CR2032 coin-type battery cells (diameter: 20 mm, height: 3.2 mm) were fabricated with the use of the formed positive electrodes.

A lithium metal was used for a counter electrode.

As an electrolyte in the sample, 1 mol/L lithium hexafluorophosphate (LiPF₆) was used. As the electrolytic solution, a solution in which ethylene carbonate (EC) and diethyl carbonate (DEC) were mixed at a volume ratio of 3:7 was used. The amount of vinylene carbonate (VC) added as an additive was set to 2 wt % with respect to the whole solvent.

As a separator, 25-μm-thick polypropylene was used.

A positive electrode can and a negative electrode can that were formed of stainless steel (SUS) were used.

In the evaluation of cycle characteristics, the charging voltage was 4.5 V. The measurement temperatures were 25° C. and 45° C. CC/CV charging (0.5 C, 0.05 C cut) and CC discharging (0.5 C, 2.7 V cut) were performed, and a 10-minute break was taken before the next charging. Note that 1 C was set to 200 mA/g in this example.

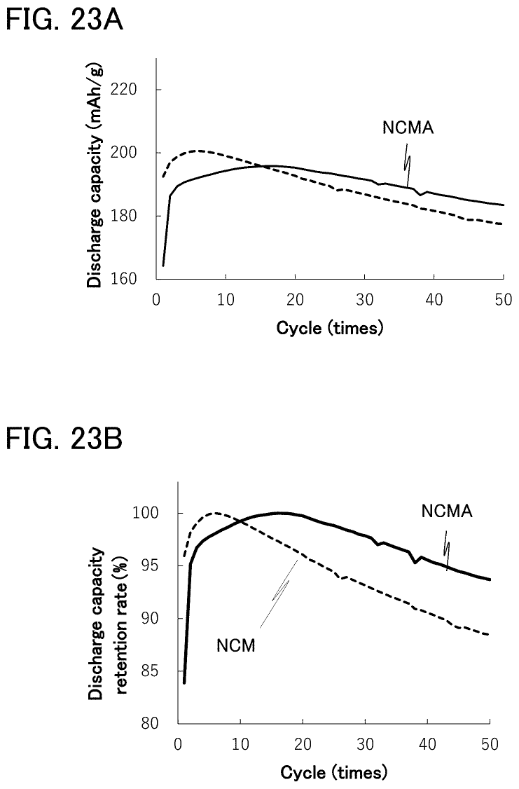

FIGS. 23A and 23B show cycle characteristics at a measurement temperature of 25° C. The vertical axis in FIG. 23A represents discharge capacity and the vertical axis in FIG. 23B represents the discharge capacity retention rate.

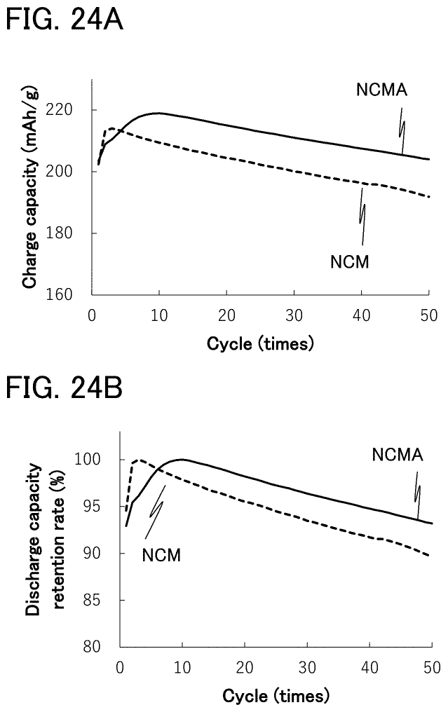

FIGS. 24A and 24B show cycle characteristics at a measurement temperature of 45° C. The vertical axis in FIG. 24A represents discharge capacity and the vertical axis in FIG. 24B represents the discharge capacity retention rate.

Note that the comparative example in FIGS. 24A and 24B is NCM with an element ratio Ni:Co:Mn=8:1:1.

From the results of FIG. 23B, it was confirmed that NCMA, the positive electrode active material with higher crushing strength than that of NCM of the comparative example, has a high capacity retention rate in a charging cycle.

A battery cell was fabricated in the following manner: a cobalt compound including nickel, cobalt, and manganese with an element ratio Ni:Co:Mn=8:1:1 (also referred to as a nickel compound because the proportion of nickel is high) was obtained by the coprecipitation method in accordance with Embodiment 1; heat treatment was performed twice (first heat treatment was performed at 500° C. for 10 hours, the temperature was returned to room temperature, crushing was performed, and then second heat treatment was performed at 800° C. for 10 hours). The discharge capacity of a half cell of the comparative example (heat treatment was performed once) was 213 mAh/g (measurement temperature: 45° C.), whereas the discharge capacity of a half cell of NCM (heat treatment was performed twice) was 227 mAh/g (measurement temperature: 45° C.), which is larger than the comparative example. These results show effectiveness of twice-heat treatment process even when aluminum is not added.

This application is based on Japanese Patent Application Serial No. 2021-001989 filed with Japan Patent Office on Jan. 8, 2021 and Japanese Patent Application Serial No. 2021-020833 filed with Japan Patent Office on Feb. 12, 2021, the entire contents of which are hereby incorporated by reference.

What is claimed is:

1. A method of forming a positive electrode active material, comprising the steps of:
supplying an aqueous solution containing a water-soluble nickel salt, a water-soluble cobalt salt, and a water-soluble manganese salt and an alkaline solution to a reaction tank;
performing mixing in the reaction tank to precipitate hydroxide;
heating a mixture obtained by mixing the hydroxide and a lithium compound at first heating temperature;
performing grinding or crushing on the heated mixture; and
heating the ground or crushed mixture at second heating temperature that is higher than the first heating temperature.

2. The method of forming a positive electrode active material according to claim 1, wherein an aqueous solution containing aluminum is further supplied to the reaction tank.

3. The method of forming a positive electrode active material according to claim 1, wherein an aqueous solution containing magnesium is further supplied to the reaction tank.

4. The method of forming a positive electrode active material according to claim 1, wherein an aqueous solution containing calcium is further supplied to the reaction tank.

5. The method of forming a positive electrode active material according to claim 1, wherein the alkaline solution is an aqueous solution containing sodium hydroxide.

6. The method of forming a positive electrode active material according to claim 1, wherein a mixed solution obtained by mixing the aqueous solution and the alkaline solution has a pH of greater than or equal to 9 and less than or equal to 11.

7. The method of forming a positive electrode active material according to claim 1, wherein when the aqueous solution and the alkaline solution are mixed to precipitate the hydroxide, an aqueous solution containing glycine is added.

8. The method of forming a positive electrode active material according to claim 1,
wherein the first heating temperature is higher than or equal to 400° C. and lower than or equal to 700° C., and
wherein the second heating temperature is higher than 700° C. and lower than or equal to 1050° C.

9. A secondary battery comprising a positive electrode formed with a positive electrode active material obtained by the method according to claim 1.

10. A method of forming a positive electrode active material, comprising the steps of:
supplying an aqueous solution containing a water-soluble nickel salt, a water-soluble cobalt salt, and a water-soluble manganese salt and an alkaline solution to a reaction tank;
performing mixing in the reaction tank to precipitate a cobalt compound;
heating a mixture obtained by mixing the cobalt compound, a lithium compound, and an aluminum compound at first heating temperature;
performing grinding or crushing on the heated mixture; and
heating the ground or crushed mixture at second heating temperature that is higher than the first heating temperature.

11. The method of forming a positive electrode active material according to claim 10, wherein an aqueous solution containing magnesium is further supplied to the reaction tank.

12. The method of forming a positive electrode active material according to claim 10, wherein an aqueous solution containing calcium is further supplied to the reaction tank.

13. The method of forming a positive electrode active material according to claim 10, wherein the alkaline solution is an aqueous solution containing sodium hydroxide.

14. The method of forming a positive electrode active material according to claim 10, wherein a mixed solution obtained by mixing the aqueous solution and the alkaline solution has a pH of greater than or equal to 9 and less than or equal to 11.

15. The method of forming a positive electrode active material according to claim 10, wherein when the aqueous solution and the alkaline solution are mixed to precipitate the cobalt compound, an aqueous solution containing glycine is added.

16. The method of forming a positive electrode active material according to claim 10,
wherein the first heating temperature is higher than or equal to 400° C. and lower than or equal to 700° C., and
wherein the second heating temperature is higher than 700° C. and lower than or equal to 1050° C.

17. A secondary battery comprising a positive electrode formed with a positive electrode active material obtained by the method according to claim 10.
